(19) United States
(12) Patent Application Publication
(10) Pub. No.: US 2007/0159586 A1
(43) Pub. Date: Jul. 12, 2007

(54) Liquid crystal display

(75) Inventors: Hee-seop Kim, Hwaseong-si (KR); JianGang Lu, Yongin-si (KR); Eun-hee Han, Seoul (KR); Chang-hun Lee, Yongin-si (KR); Jun-woo Lee, Anyang-si (KR)

Correspondence Address: F. Chau & Associates, LLC, 130 Woodbury Road, Woodbury, NY, 11797, US

(73) Assignee: Samsung Electronics Co., Ltd.

(21) Appl. No.: 11/543,173

(22) Filed: Oct. 4, 2006

(30) Foreign Application Priority Data
Oct. 19, 2005 (KR) 10-2005-0098823

(51) Int. Cl. G02F 1/1343

(52) U.S. Cl. 349/143

(57) ABSTRACT

A liquid crystal display includes a first plate including first and second field-generating electrodes disposed in a pixel area of an insulating substrate and electrically separated from each other in a cross-finger structure, and a first alignment film covering the first and second field-generating electrodes and rubbed in a first direction; a second plate formed of an insulating substrate and including a third field-generating electrode, a plurality of field-generating portions and openings, and a second alignment film covering the third field-generating electrode and rubbed in a second direction; and a liquid crystal layer interposed between the first plate and the second plate.

### CROSS REFERENCE TO RELATED FOREIGN APPLICATIONS

This application claims priority from Korean Patent Application No. 10-2005-0098823 filed on Oct. 19, 2005 in the Korean Intellectual Property Office, the contents of which are incorporated herein by reference in their entirety.

### BACKGROUND OF THE INVENTION

1. Field of the Invention

The present invention relates to a flat display, and, more particularly, to a liquid crystal display with an improved transmittance.

2. Description of the Related Art

A liquid crystal display (LCD) is one of the most widely used flat panel displays. An LCD includes two substrates provided with electrodes and a liquid crystal (LC) layer interposed therebetween. The LCD displays images by applying voltages to the electrodes to generate the electric field in the LC layer, which rearranges LC molecules in the LC layer to adjust transmittance of incident light.

A vertical alignment (VA) mode LCD, which aligns LC molecules such that the long axes of the LC molecules are perpendicular to the substrates in absence of electric field, is spotlighted because of its high contrast ratio and wide reference viewing angle. The wide viewing angle of the VA mode LCD can be realized by cutouts in the field-generating electrodes and protrusions on the field-generating electrodes. That is to say, since the cutouts and the protrusions evenly distribute tilt directions of the LC molecules into four directions by forming fringe fields, a wide viewing angle can be achieved.

Specifically, a patterned vertically aligned (PVA) mode LCD in which cutouts are formed in an electrode can be considered as being a substitute for an in-plane switching (IPS) mode or plane-to-line switching (PLS) mode LCD.

However, in liquid crystal displays, a patterned vertically aligned (PVA)-mode shows a lateral gamma curve distortion where a front gamma curve and a lateral gamma curve do not agree with each other, and thus exhibits lower visibility laterally compared with a twisted nematic (TN)-mode. Thus, there is still a need to develop a new liquid crystal display capable of substituting for the In-Plane Switching (IPS) mode or plane-to-line switching (PLS) mode.

### SUMMARY OF THE INVENTION

Embodiments of the present invention provide a liquid crystal display with improved transmittance.

Embodiments of the present invention also provide a liquid crystal display with a wide viewing angle.

According to an aspect of the present invention, there is provided a liquid crystal display including a first plate including first and second field-generating electrodes electrically separated from each other in a cross-finger structure disposed in a pixel area of an insulating substrate, and a first alignment film covering the first and second field-generating electrodes and-rubbed in a first direction, a second plate formed on an insulating substrate and including a third field-generating electrode, a plurality of field-generating portions and openings, and a second alignment film covering the third field-generating electrode and rubbed in a second direction, and a liquid crystal layer interposed between the first plate and the second plate.

According to another aspect of the present invention, there is provided a liquid crystal display comprising a first plate including a pixel electrode and an additional electrode in a cross-finger structure disposed in a pixel area of an insulating substrate, each of the pixel electrode and the additional electrode including a plurality of sub-electrodes and a connection electrode which connects the sub electrodes with one another, and a first horizontal alignment film covering the pixel electrode and the additional electrode and rubbed in a first direction, a second plate formed on an insulating substrate and including a common electrode having a field-generating portion and a plurality of openings, and a second horizontal alignment film covering the common electrode and rubbed in a second direction, and a liquid crystal layer interposed between the first plate and the second plate.

According to still another aspect of the present invention, there is provided a liquid crystal display comprising a first plate including a pixel electrode, an additional electrode disposed in a pixel area of an insulating substrate and a first horizontal alignment film covering the pixel electrode, the pixel electrode and the additional electrode configured in a cross-finger structure and including a plurality of sub-electrodes and a connection electrode connecting the sub-electrodes with one another, each of the plurality of sub-electrodes including a plurality of sub-branch electrodes, a second plate formed on an insulating substrate and including a common electrode having a field-generating portion and a plurality of openings, and a second horizontal alignment film covering the common electrode and rubbed in a second direction, and a liquid crystal layer interposed between the first plate and the second plate.

### BRIEF DESCRIPTION OF THE DRAWINGS

FIG. 1 is a layout view of a liquid crystal display according to an embodiment of the present invention.

FIG. 2 is a layout view of a first plate of the liquid crystal display according to an embodiment of the present invention.

FIG. 3 is a layout view of a second plate of the liquid crystal display according to an embodiment of the present invention.

FIG. 4 is a sectional view taken along the line IV-IV′ of FIG. 1.

FIG. 5 is a schematic plan view illustrating the arrangement of liquid crystal molecules when the thin film transistor of the liquid crystal display according to an embodiment of the present invention is in an “OFF” state.

FIG. 6 is a schematic plan view illustrating the arrangement of liquid crystal molecules when the thin film transistor of the liquid crystal display according to an embodiment of the present invention is in an “ON” state.

FIG. 7 is a schematic sectional view illustrating the arrangement of liquid crystal molecules in “OFF” and “ON” states of the thin film transistor of the liquid crystal display according to an embodiment of the present invention.

FIG. 8 is a layout view of a liquid crystal display according to another embodiment of the present invention.

FIG. 9 is a layout view of a first plate of the liquid crystal display according to an embodiment of the present invention.

FIG. 10 is a layout view of a second plate of the liquid crystal display according to an embodiment of the present invention.

FIG. 11 is a sectional view taken along the line XI-XI′ of FIG. 8.

FIGS. 12A and 12B are schematic plan views illustrating the arrangement of liquid crystal molecules when the thin film transistor of the liquid crystal display according to an embodiment of the present invention is in an “OFF” state.

FIGS. 13A and 13B are schematic plan views illustrating the arrangement of liquid crystal molecules when the thin film transistor of the liquid crystal display according to an embodiment of the present invention is in an “ON” state.

FIG. 14 is a layout view of a liquid crystal display according to another embodiment of the present invention.

FIG. 15 is a layout view of a first plate of the liquid crystal display according to an embodiment of the present invention.

FIG. 16 is a layout view of a second plate of the liquid crystal display according to an embodiment of the present invention.

FIG. 17 is a sectional view taken along the line XVII-XVII′ of FIG. 14.

FIG. 18 is a schematic plan view illustrating the arrangement of liquid crystal molecules when the thin film transistor of the liquid crystal display according to an embodiment of the present invention is in an “OFF” state.

FIG. 19 is a schematic plan view illustrating the arrangement of liquid crystal molecules when the thin film transistor of the liquid crystal display according to an embodiment of the present invention is in an “ON” state.

FIG. 20 is a layout view of a liquid crystal display according to another embodiment of the present invention.

FIG. 21 is a layout view of a first plate of the liquid crystal display according to an embodiment of the present invention.

FIG. 22 is a layout view of a second plate of the liquid crystal display according to an embodiment of the present invention.

FIG. 23 is a sectional view taken along the line XXIII-XXIII′ of FIG. 20.

FIGS. 24A and 24B are schematic plan views illustrating the arrangement of liquid crystal molecules when the thin film transistor of the liquid crystal display according to an embodiment of the present invention is in an “OFF” state.

FIGS. 25A and 25B are schematic plan views illustrating the arrangement of liquid crystal molecules when the thin film transistor of the liquid crystal display according to an embodiment of the present invention is in an “ON” state.

FIG. 26 is a layout view of a liquid crystal display according to another embodiment of the present invention.

FIG. 27 is a layout view of a first plate of the liquid crystal display according to an embodiment of the present invention.

FIG. 28 is a layout view of a second plate of the liquid crystal display according to an embodiment of the present invention.

FIG. 29 is a sectional view taken along the line XXIX-XXIX′ of FIG. 26.

FIG. 30 is a schematic plan view illustrating the arrangement of liquid crystal molecules when the thin film transistor of the liquid crystal display according to an embodiment of the present invention is in an “OFF” state.

FIG. 31 is a schematic plan view illustrating the arrangement of liquid crystal molecules when the thin film transistor of the liquid crystal display according to an embodiment of the present invention is in an “ON” state.

FIG. 32 is a layout view of a liquid crystal display according to another embodiment of the present invention.

FIG. 33 is a layout view of a first plate of the liquid crystal display according to an embodiment of the present invention.

FIG. 34 is a layout view of a second plate of the liquid crystal display according to an embodiment of the present invention.

FIG. 35 is a sectional view taken along the line XXXV-XXXV′ of FIG. 32.

FIGS. 36A and 36B are schematic plan views illustrating the arrangement of liquid crystal molecules when the thin film transistor of the liquid crystal display according to an embodiment of the present invention is in an “OFF” state.

FIGS. 37A and 37B are schematic plan views illustrating the arrangement of liquid crystal molecules when the thin film transistor of the liquid crystal display according to an embodiment of the present invention is in an “ON” state.

FIG. 38 is a layout view of a liquid crystal display according to another embodiment of the present invention.

FIG. 39 is a layout view of a first plate of the liquid crystal display according to an embodiment of the present invention.

FIG. 40 is a layout view of a second plate of the liquid crystal display according to an embodiment of the present invention.

FIG. 41 is a sectional view taken along the line XXXXI-XXXXI′ of FIG. 38.

FIG. 42 is a schematic plan view illustrating the arrangement of liquid crystal molecules when the thin film transistor of the liquid crystal display according to an embodiment of the present invention is in an “OFF” state.

FIG. 43 is a schematic plan view illustrating the arrangement of liquid crystal molecules when the thin film transistor of the liquid crystal display according to an embodiment of the present invention is in an “ON” state.

FIG. 44 is a layout view of a liquid crystal display according to another embodiment of the present invention.

FIG. 45 is a layout view of a first plate of the liquid crystal display according to an embodiment of the present invention.

FIG. 46 is a layout view of a second plate of the liquid crystal display according to an embodiment of the present invention.

FIG. 47 is a sectional view taken along the line XXXXVII-XXXXVII′ of FIG. 44.

FIGS. 48A and 48B are schematic plan views illustrating the arrangement of liquid crystal molecules when the thin film transistor of the liquid crystal display according to an embodiment of the present invention is in an “OFF” state.

FIGS. 49A and 49B are schematic plan views illustrating the arrangement of liquid crystal molecules when the thin film transistor of the liquid crystal display according to an embodiment of the present invention is in an “ON” state.

FIGS. 50 through 52 are sectional diagrams illustrating equipotential lines formed in the “ON” state of thin film transistors of liquid crystal displays of Experimental Examples 1 through 3, respectively.

### DETAILED DESCRIPTION OF THE EXEMPLARY EMBODIMENTS

Exemplary embodiments of the present invention and methods of accomplishing the same may be understood more readily by reference to the following detailed description in connection with the accompanying drawings. The present invention may, however, be embodied in many different forms and should not be construed as being limited to the embodiments set forth herein

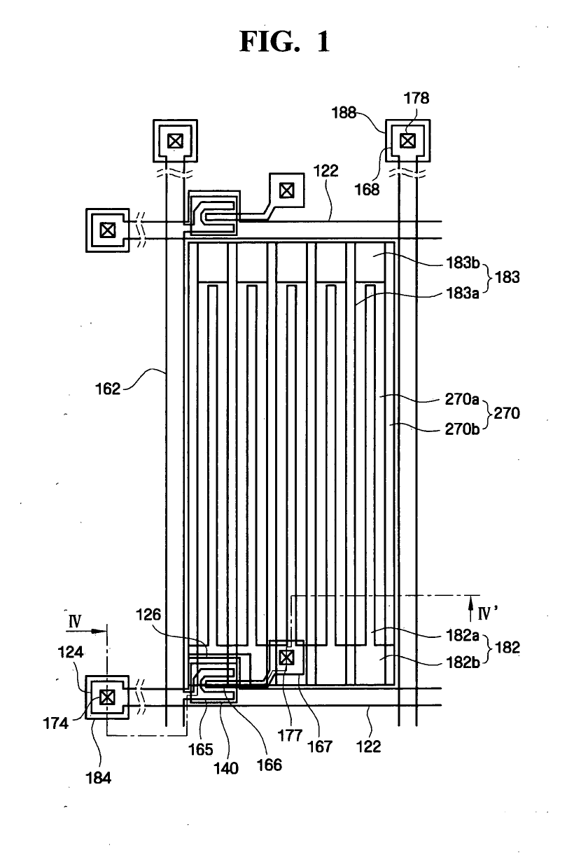

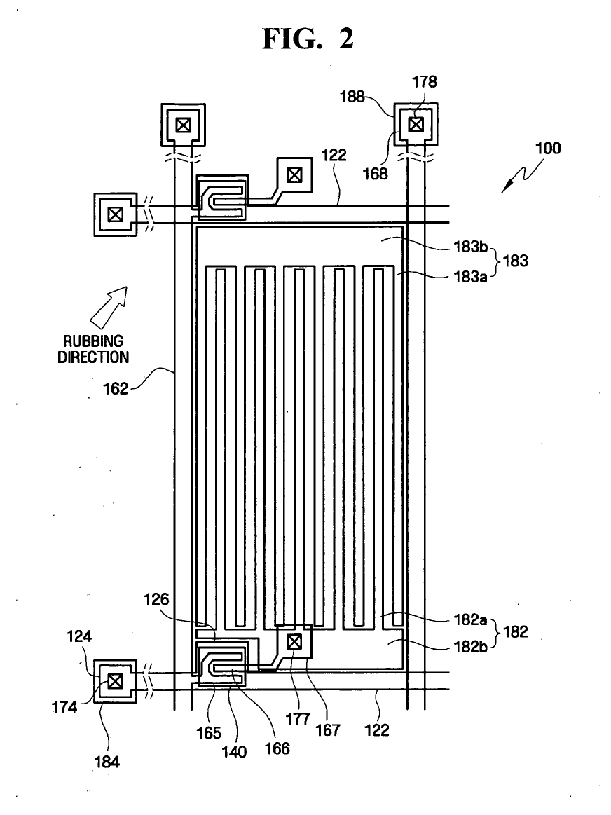

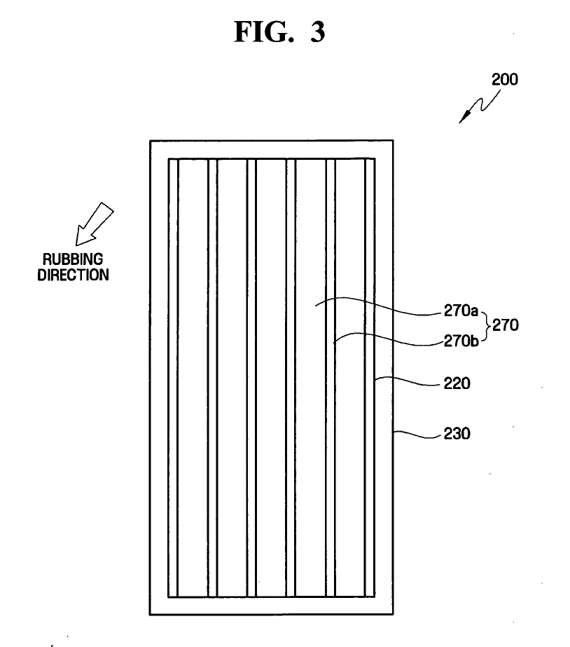

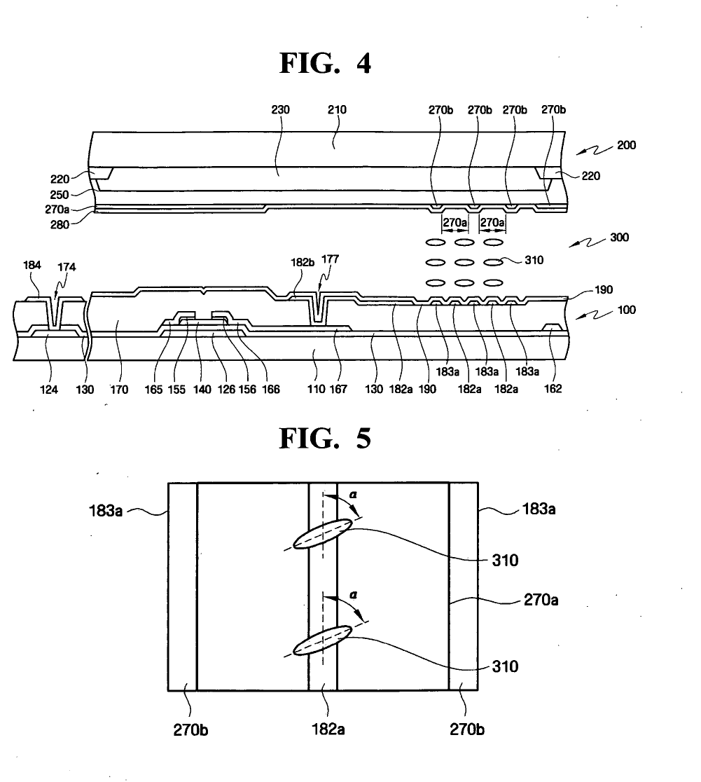

First, a liquid crystal display according to another embodiment of the present invention will first be described with reference to FIGS. 1 through 4. FIG. 1 is a layout view of a liquid crystal display according to another embodiment of the present invention, FIG. 2 is a layout view of a first plate of the liquid crystal display according to an embodiment of the present invention, FIG. 3 is a layout view of a second plate of the liquid crystal display according to an embodiment of the present invention, and FIG. 4 is a sectional view taken along the line IV-IV′ of FIG. 1.

A liquid crystal display includes a first plate, a second plate facing the first plate, and a liquid crystal layer, interposed between the first plate and the second plate, including liquid crystal molecules aligned horizontally with respect to the first and second plates.

In detail, with respect to the first plate 100, a pixel electrode 182, which is a field-generating electrode, is formed on a substrate 110 made of a transparent insulating material, such as glass. The pixel electrode 182 is made of transparent conductive oxide, such as indium tin oxide (ITO) or indium zinc oxide (IZO), and includes a plurality of sub-electrodes 182a parallel to and spaced a predetermined distance from each other and a connection electrode 182b electrically connecting adjacent sub-electrodes 182a with each other.

The pixel electrode 182 is connected to a thin film transistor to receive an image signal voltage. The thin film transistor is connected to a gate line 122 responsible for scan signal transmission and a data line 162 responsible for image signal transmission, and turns ON/OFF the pixel electrode 182 according to scan signals.

An additional electrode 183 is also formed on the substrate 110 to enhance a horizontal electric field produced in the liquid crystal display. The additional electrode 183 is made of transparent conductive oxide, such as ITO or IZO, and includes a plurality of sub-electrodes 183a parallel to and spaced a predetermined distance from each other and a connection electrode 183b electrically connecting the plurality of sub-electrodes 183a with one another. The additional electrode 183 is electrically separated from the pixel electrode 182 and forms a cross-finger structure together with the pixel electrode 182. As used herein, the term “cross-finger structure” refers to an interdigitated shape in which the sub-electrodes 182a of the pixel electrode 182 are alternately engaged with the sub-electrodes 183a of the additional electrode 183.

An alignment film 190 is formed on the substrate 110 having thereon the pixel electrode 182 and the additional electrode 183. The alignment film 190 allows the liquid crystal molecules 310 of the liquid crystal layer 300 to be horizontally aligned in an initial state in which no voltage is applied to the liquid crystal display.

In addition, with respect to the second plate 200, a black matrix 220 for preventing light leakage, a color filter 230 composed of red, green, and blue components, and a common electrode 270, which is a field-generating electrode being made of transparent conductive oxide, such as ITO or IZO, and including a plurality of openings 270a and a plurality of field-generating portions 270b, are formed on a lower surface of a substrate 210 made of a transparent insulating material, such as glass.

An alignment film 280 is formed on the substrate 210 having thereon the common electrode 270. The alignment film 280 allows the liquid crystal molecules 310 of the liquid crystal layer 300 to be horizontally aligned in an initial state in which no voltage is applied to the liquid crystal display.

The first plate 100 will now be described in greater detail. Referring to FIGS. 2 and 4, gate wires formed on the insulating substrate 10 include the gate line 122 extending in a transverse direction, a gate pad 124 connected to an end of the gate line 122 to receive a gate signal from an external device and transmit the received gate signal to the gate line 122, and a gate electrode 126 of a thin film transistor which is connected to the gate line 122 in a protrusion shape. Here, the gate wires 122, 124, and 126 may be formed on the insulating substrate 110 using a material, such as Al, Cu, Mo, Cr, Ti, Ta, or an alloy thereof, but not limited thereto, by sputtering, followed by patterning using photolithography. The gate wires 122, 124, and 126 may have a single layered structure including a conductive layer made of an Al containing metal, such as Al or an Al alloy, or a multi-layered structure (not shown) including another layer made of, particularly, a material that shows physically, chemically and electrically good contact characteristics with respect to ITO or IZO, such as Cr, Ti, Ta, Mo or an alloy thereof, formed on the conductive layer.

A gate insulating film 130 made of silicon nitride (SiNx), etc. is formed on a substrate 110 and gate wires 122, 124, and 126.

Data wires are formed on the gate insulating film 130. The data wires extending along a longitudinal direction intersect the gate wires, defining a pixel area shaped of, for example, a rectangle.

The data wires include a data line 162, a source electrode 165 as a branch of the data line 162, a drain electrode 166 formed in the neighbourhood of the source electrode 165 and a data pad 168 formed at an end of the data line 162. Like the gate wires, the data line 162, the source electrode 165, the drain electrode 166, and the data pad 168 may have a single layered structure including a conductive layer made of an Al containing metal, such as Al or an Al alloy, or a multi-layered structure (not shown) including another layer made of, particularly, a material that shows physically, chemically and electrically good contact characteristics with respect to ITO or IZO, such as Cr, Ti, Ta, Mo or an alloy thereof, formed on the conductive layer.

A semiconductor layer 140 defining a channel region of a thin film transistor is formed in an island shape below the source electrode 165 and the drain electrode 166. In addition, ohmic contact layers 155 and 156 are formed of, for example, silicide or n+ hydrogenated silicon doped with a high concentration of n-type impurities, on the semiconductor layer 140 to reduce contact resistance between the source/drain electrodes 165 and 166 and the semiconductor layer 140.

The passivation layer 170 made of an inorganic insulating material, such as silicon nitride or an organic insulating material, such as resin is formed on the data wires. Contact holes 177 and 178 exposing the drain electrode 166 and the data pad 168, respectively, are formed on the passivation layer 170. In addition, a contact hole 174 is formed on the passivation layer 170 through the gate insulating layer 130 to expose the gate pad 124.

The pixel electrode 182 electrically connected to the drain electrode 166 via the contact hole 177 is formed on the passivation layer 170. The pixel electrode 182 includes the plurality of sub-electrodes 182a and the connection electrode 182b electrically connecting the plurality of sub-electrodes 182a with one another.

Each of the plurality of sub-electrodes 182a of the pixel electrode 182 may have a predetermined shape, for example, stripes formed in parallel with longer sides of a pixel area. In this case, a width of each of the sub-electrodes 182a and a distance between the sub-electrodes 182a depend on optical properties of an LCD. For example, a width of each of the sub-electrodes 182a may be approximately 7 μm or less, and a distance between the sub-electrodes 182a may range from approximately 8 to approximately 20 μm. If the width of each of the sub-electrodes 182a is 4 μm, the distance between the sub-electrodes 182a may be approximately 9 μm.

The connection electrode 182b of the pixel electrode 182 is formed to electrically connect adjacent sub-electrodes 182a with each other. The connection electrode 182b may be formed by connecting adjacent sub-electrodes at either side or opposite sides, or by connecting central portions of adjacent sub-electrodes. However, the location of the connection electrode 182b is not particularly limited to the stated examples.

The additional electrode 183 is formed on the passivation layer 170 and forms a cross-finger structure together with the pixel electrode 182. The additional electrode 183 is also a kind of a field-generating electrode and enhances a horizontal electric field produced in the liquid crystal display. The additional electrode 183 includes a plurality of sub-electrodes 183a and the connection electrode 183b electrically connecting the plurality of sub-electrodes 183a with each other.

Each of the plurality of sub-electrodes 183a of the additional electrode 183 may have a predetermined shape, for example, stripes formed in parallel with longer sides of a pixel area. In this case, a width of each of the sub-electrodes 183a and a distance between the sub-electrodes 183a depend on optical properties of an LCD. For example, a width of each of the sub-electrodes 182a may be approximately 7 μm or less, and a distance between the sub-electrodes 182a may range from approximately 8 to approximately 20 μm. If the width of each of the sub-electrodes 182a is 4 μm, the distance between the sub-electrodes 183a may be approximately 9 μm.

The connection electrode 183b of the additional electrode 183 is formed to electrically connect adjacent sub-electrodes 183a with each other. The connection electrode 183b may be formed by connecting adjacent sub-electrodes at either side or opposite sides, or by connecting central portions of adjacent sub-electrodes. However, the location of the connection electrode 183b is not particularly limited to the stated examples.

In addition, to apply a predetermined voltage V_{add} to the additional electrode 183, a portion of the connection electrode 183b may be branched out and extended along the data line 162 to then be connected with an auxiliary data pad 188 (not shown), which will later be described.

The pixel electrode 182 applied with a pixel voltage generates the electric field together with the common electrode 270 of the second plate 200, thereby determining the directions of the liquid crystal molecules 310 of the liquid crystal layer 300 between pixel electrode 182 and the common electrode 270.

An auxiliary gate pad 184 and the auxiliary data pad 188 connected to the gate pad 124 and a data pad 168 via the contact holes 174 and 178, respectively, are also formed on the passivation layer 170. The auxiliary gate pad 184 and the auxiliary data pad 188 complement adhesions to external circuit devices and protect the gate pad 124 and the data pad, 168. The auxiliary gate pad 184 and the auxiliary data pad 188 may be made of ITO or IZO.

As referenced above, the alignment film 190 is formed on the substrate 110 having the pixel electrode 182. The alignment film 190 is a horizontal-alignment film that allows the liquid crystal molecules 310 of the liquid crystal layer 300 to be aligned horizontally with respect to the substrate 110 in an initial state.

In addition, to prevent the formation of two or more domains in a voltage-on state, the alignment film 190 allows the liquid crystal molecules 310 to have a pretilt angle of, for example, about 0.5 to 3 degrees, The alignment film 190 may be rubbed so that the liquid crystal molecules 310 of the liquid crystal layer 300 are aligned at an angle of a with respect to the sub-electrodes 182a in a voltage-off state. Here, the angle of a may depend upon optical properties of the liquid crystal display, and may be an arbitrary angle other than 0 and 90 degrees. For example, the angle of a may be within the range of between 60 and 85 degrees.

Next, the second plate 200 will be described in more detail. Referring to FIGS. 3 and 4, the black matrix 220 is formed on the second plate 200 facing the first plate 100 to prevent light leakage. The color filter 230 composed of red, green, and blue components is formed on the black matrix 220, and an overcoat layer 250 is formed on the color filter 230 to planarize the stepped surface of the color filter 230.

The common electrode 270 is formed on the overcoat layer 250. The common electrode 270 includes the plurality of openings 270a and the plurality of field-generating portions 270b of the common electrode 270. The openings 270a of the common electrode 270 are formed parallel to sub-electrodes 182a of the pixel electrode 182 with the liquid crystal layer 300 interposed therebetween. The widths of the openings 270a of the common electrode 270 are equal to or greater than those of the sub-electrodes 182a so that the sub-electrodes 182a are not substantially overlapped with the field-generating portions 270b of the common electrode 270. The reason of the foregoing will be described later.

The widths of the openings 270a are determined by set optical properties of the liquid crystal display and the widths of the sub-electrodes 182a and 183a . For example, each of openings 270a may have a width of approximately 8 to 20 μm. For example, if the width of each sub-electrode 182a is 4 μm, the width of each of the openings 270a may be approximately 12 μm.

In addition, a width between each of the openings 270a and each of the field-generating portions 270b of the common electrode 270 may depend upon the set optical properties of the liquid crystal display and the widths of the sub-electrodes 182a and 183a and the openings 270a. For example, the width between each of the openings 270a and each of the field-generating portions 270b is approximately 7 μm or less.

The alignment film 280 is formed on the substrate 210 having thereon the common electrode 270. The alignment film 280 is substantially the same as the alignment film 190 formed on the first plate 100 except that it is rubbed to form an angle of about 180 degrees, and a repeated explanation will not be given.

The liquid crystal layer 300 including the liquid crystal molecules 310 is interposed between the first plate 100 having the thin film transistor and the second plate 200 having the color filter. The liquid crystal molecules 310 are horizontally aligned between the first plate 100 and the second plate 200, and have negative dielectric anisotropy (Δε<0), i.e., the long axes of the liquid crystal molecules 310 are aligned vertically with respect to a field generating direction.

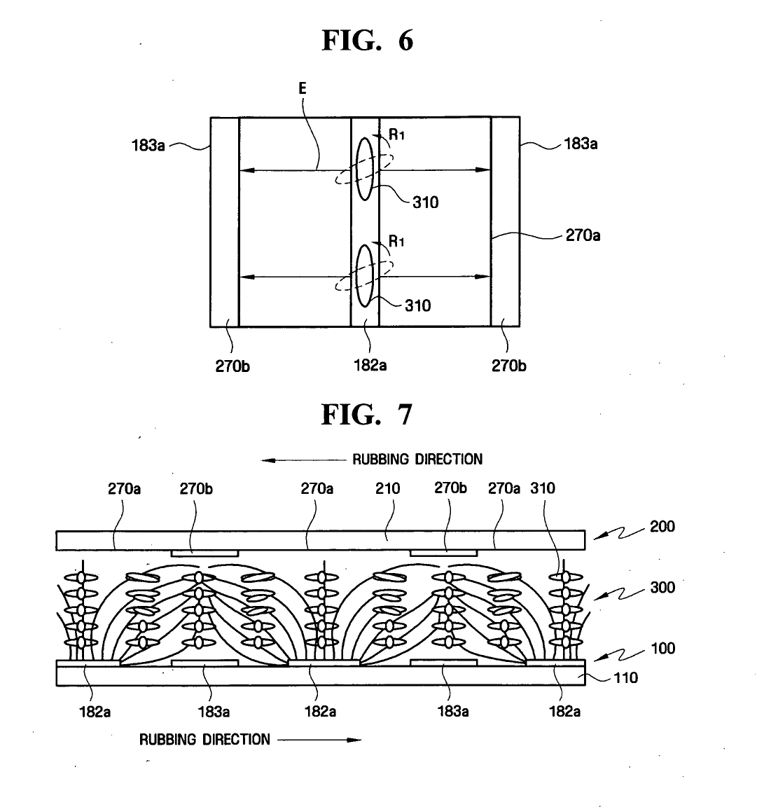

Next, the arrangement of the liquid crystal molecules 310 in the ON/OFF state of a thin film transistor of the liquid crystal display according to the illustrative embodiment will now be described with reference to FIGS. 4 through 7. FIG. 5 is a schematic plan view illustrating the arrangement of liquid crystal molecules when the thin film transistor of the liquid crystal display according to an embodiment of the present invention is in an “OFF” state, FIG. 6 is a schematic plan view illustrating the arrangement of liquid crystal molecules when the thin film transistor of the liquid crystal display according to an embodiment of the present invention is in an “ON” state, and FIG. 7 is a schematic sectional view illustrating the arrangement of liquid crystal molecules in “OFF” and “ON” states of the thin film transistor of the liquid crystal display according to an embodiment of the present invention.

First, with respect to the arrangement of the liquid crystal molecules 310 in an “OFF” state thin film transistor, referring to FIGS. 4, 5, and 7, the long axes of the liquid crystal molecules 310 are inclined parallel to the rubbing direction of the alignment films 190 and 280, of the first plate 100 and the second plate 200, i.e., at an angle of about 60 to 85 degrees with respect to the sub-electrodes 182a and 183a. That is, the long axes of the liquid crystal molecules 310 have a tilt angle α of about 60 to 85 degrees with respect to the sub-electrodes 182a and 183a.

Next, with respect to the arrangement of the liquid crystal molecules 310 in an “ON” state thin film transistor, referring to FIGS. 4 6, and 7, when the thin film transistor is turned-on and an image signal is applied to the pixel electrode 182, the electric field E is generated between the first plate 100 and the second plate 200. A voltage applied to the additional electrode 183 may be equal to or greater than a voltage applied to the common electrode 270 and smaller than the voltage applied to the pixel electrode 182. For example, when voltages of 0V and 7V are respectively applied to the common electrode 270 and the pixel electrode 182, a voltage of 1.5-3V may be applied to the additional electrode 183, but the present invention is not limited thereto.

First, the sub-electrodes 182a of the pixel electrode 182 and the field-generating portions 270b of the common electrode 270 are alternately formed, with the liquid crystal layer 300 being interposed therebetween. Thus, a horizontal electric field is generated between the pixel electrode 182 and the common electrode 270, the horizontal electric field being not perpendicular parallel but curved.

In addition, the electric field is generated by a voltage difference between the pixel electrode 182 and the additional electrode 183. A relatively strong horizontal electric field is generated since the pixel electrode 182 and the additional electrode 183 are positioned on the same plane. An electric field may also be generated by a voltage difference between the additional electrode 183 and the common electrode 270.

As described above, compared to the conventional liquid crystal display without an additional electrode, the liquid crystal display according to an embodiment of the present invention including the pixel electrode 182 and the additional electrode 183 on the same plane can induce a stronger horizontal electric field. Thus, the liquid crystal molecules 310 have a much stronger motion in an azimuthal direction by a horizontal electric field than in a polar direction by a vertical electric field, thereby improving transmittance of the liquid crystal display.

As a result, the liquid crystal molecules 310 having negative dielectric anisotropy are rotated in a direction of R₁ so that their long axes are aligned vertically with respect to the electric field E, i.e., the vector summation of the electric field between the pixel electrode 182 and the additional electrode 183, the electric field between the pixel electrode 182 and the common electrode 270, and the electric field between the additional electrode 183 and the common electrode 270.

As described above, in a voltage-off state, the liquid crystal molecules 310 are tilted at a predetermined angle with respect to the sub-electrodes 182a by rubbing the alignment films 190 and 280. In a voltage-on state, the liquid crystal molecules 310 are uniformly rotated in a direction determined by the tilt angle.

As described above, in the liquid crystal display having an additional electrode according to an embodiment of the present invention, a horizontal electric field is enhanced and transmittance is improved. Furthermore, since liquid crystal molecules are tilted at a predetermined angle with respect to a plurality of sub-electrodes in an initial state in which no voltage is applied to the liquid crystal display, they can be uniformly rotated in the same direction in a voltage-on state. Therefore, when liquid crystal molecules are rotated randomly, there is no texture problem that may be caused by rotating liquid crystal molecules in different directions, thereby avoiding the occurrence of abnormal domains.

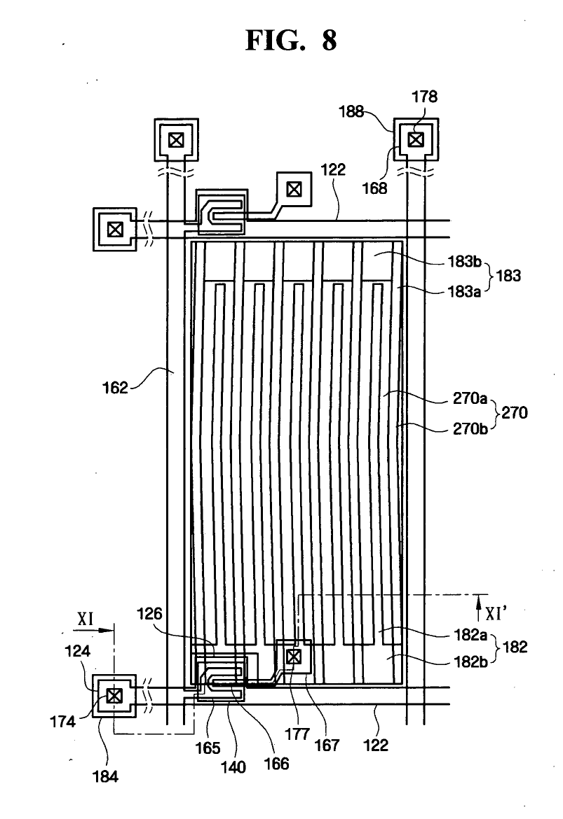

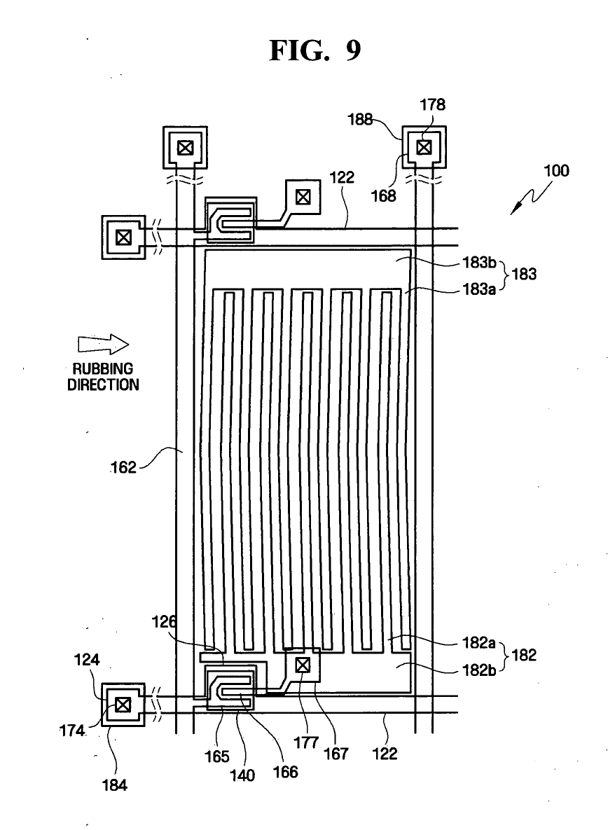

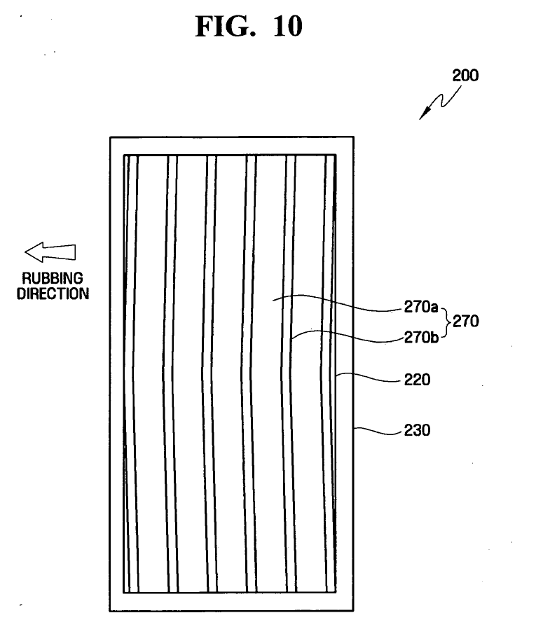

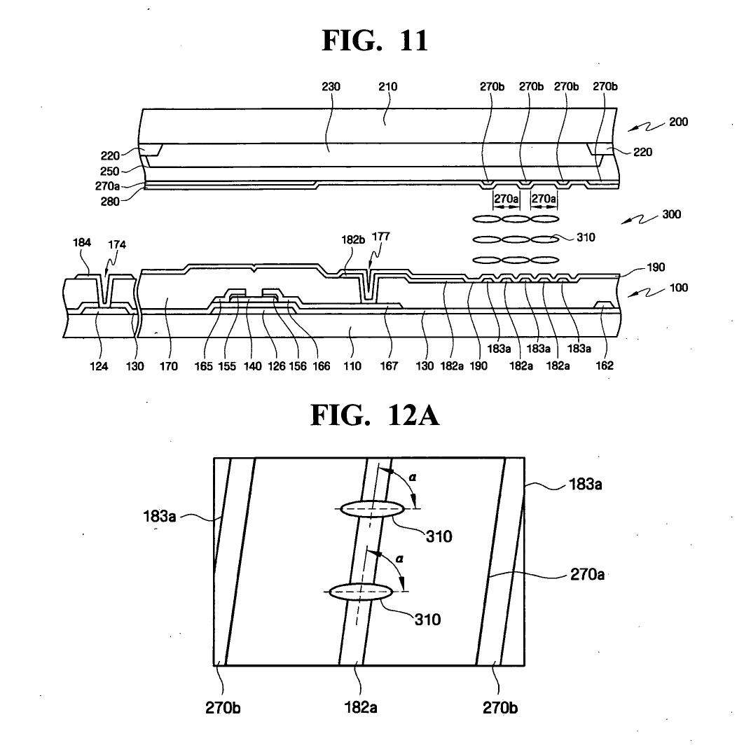

A liquid crystal display according to another embodiment of the present invention will now be described with reference to FIGS. 8 through 11. FIG. 8 is a layout view of a liquid crystal display according to another embodiment of the present invention, FIG. 9 is a layout view of a first plate 100 of the liquid crystal display according to an embodiment of the present invention, FIG. 10 is a layout view of a second plate of the liquid crystal display according to an embodiment of the present invention, and FIG. 11 is a sectional view taken along the line XI-XI′ of FIG. 8.

Since the liquid crystal display of this embodiment of the present invention is substantially the same as the liquid crystal display of the embodiment described in connection with FIGS. 1-4, only differences between the two embodiments are hereinafter described.

Referring to FIGS. 8 through 11, in the liquid crystal display of an embodiment of the present invention, alignment films 190 and 280 of the first plate 100 and the second plate 200, respectively, are rubbed at an angle of about 90 degrees with respect to the long side of a pixel area, respectively under the condition that the rubbing direction of the alignment film 190 and the rubbing direction of the alignment film 280 form an angle of about 180 degrees.

Sub-electrodes 182a and 183a and openings 270a may be arranged symmetrically with respect to the transverse centerline of a pixel area, and may be neither perpendicular nor parallel to the transverse centerline of the pixel area, which allows liquid crystal molecules 310 positioned in the pixel area to be rotated in different directions to have the same viewing angle characteristics when viewed from all directions, thereby realizing a wide viewing angle.

The sub-electrodes 182a and 183a and the openings 270a may be inclined at a predetermined angle with respect to the rubbing direction of the alignment film 190. That is, the sub-electrodes 182a and 183a and the openings 270a in an upper pixel area positioned above the transverse centerline of the pixel area may be arranged parallel to each other in a state in which they are inclined at an angle of about 60 to 85 degrees with respect to the rubbing direction of the alignment film 190. The sub-electrodes 182a and 183a and the openings 270a in a lower pixel area positioned below the transverse centerline of the pixel area may be arranged parallel to each other in a state in which they are inclined at an angle of about 60 to 85 degrees with respect to the rubbing direction of the alignment film 190 to be symmetric to the sub-electrodes 182a and 183a and the openings 270a in the upper pixel area.

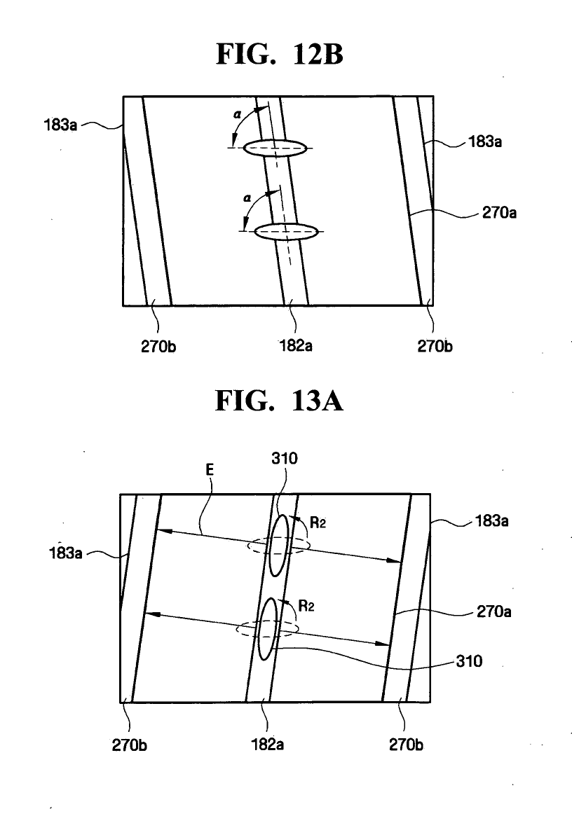

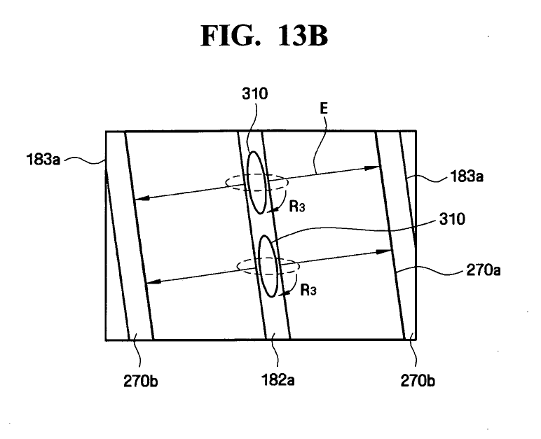

Next, the liquid crystal molecule arrangement in the ON/OFF state of the thin film transistor of the liquid crystal display according to an embodiment of the present invention will now be described with reference to FIGS. 11 through 13B. FIGS. 12A and 12B are schematic plan views illustrating the arrangement of liquid crystal molecules when the thin film transistor of the liquid crystal display according to an embodiment of the present invention is in an “OFF” state, FIGS. 13A and 13B are schematic plan views illustrating the arrangement of liquid crystal molecules when the thin film transistor of the liquid crystal display according to an embodiment of the present invention is in an “ON” state.

First, with respect to liquid crystal molecule arrangement in an “OFF” state of thin film transistor, referring to FIGS. 11 through 12B, the long axes of the liquid crystal molecules 310 are inclined parallel to the rubbing direction of the alignment films 190 and 280 of the first plate 100 and the second plate 200, i.e., at an angle of about 90 degrees with respect to the long side of the pixel area. In this case, as shown in FIG. 12A, the liquid crystal molecules 310 in the upper pixel area positioned above the transverse centerline of the pixel area may have a tilt angle α of about 60 to 85 degrees with respect to the sub-electrodes 182a and 183a. The liquid crystal molecules 310 in the lower pixel area positioned below the transverse centerline of the pixel area may be arranged symmetrically with respect to the sub-electrodes 182a and 183a, as shown in FIG. 12B.

Next, with respect to the arrangement of the liquid crystal molecules 310 in an “ON” state thin film transistor, referring to FIGS. 11 and 13A-13B, when the thin film transistor is turned-on and an image signal is applied to a pixel electrode 182, the electric field E is generated between the first plate 100 and the second plate 200.

In the same manner as in the “ON” state of the thin film transistor of the liquid crystal display according to an embodiment of the present invention, the arrangement of the liquid crystal molecules 310 is determined by the electric field E, i.e., the vector summation of the electric field between the sub-electrodes 182a of the pixel electrode 182 and field-generating portions 270b of a common electrode 270, the electric field between the sub-electrodes 182a of the pixel electrode 182 and the sub-electrodes 183a of the additional electrode 183, and the electric field between the sub-electrodes 183a of the additional electrode 183 and the field-generating portions 270b of the common electrode 270. Thus, the liquid crystal molecules 310 having negative dielectric anisotropy are rotated in the direction of R₂ (FIG. 13A) or R₃ (FIG. 13B) such that their long axes are aligned perpendicular with respect to the field generating direction.

As described above, the liquid crystal display according to an embodiment of the present invention has sub-electrodes and openings disposed symmetrically with respect to the transverse centerline of a pixel area, the sub-electrodes and openings being neither perpendicular nor parallel to the transverse centerline of the pixel area, thereby improving a viewing angle and avoiding the occurrence of a rubbing angle error that may be caused when alignment films are rubbed.

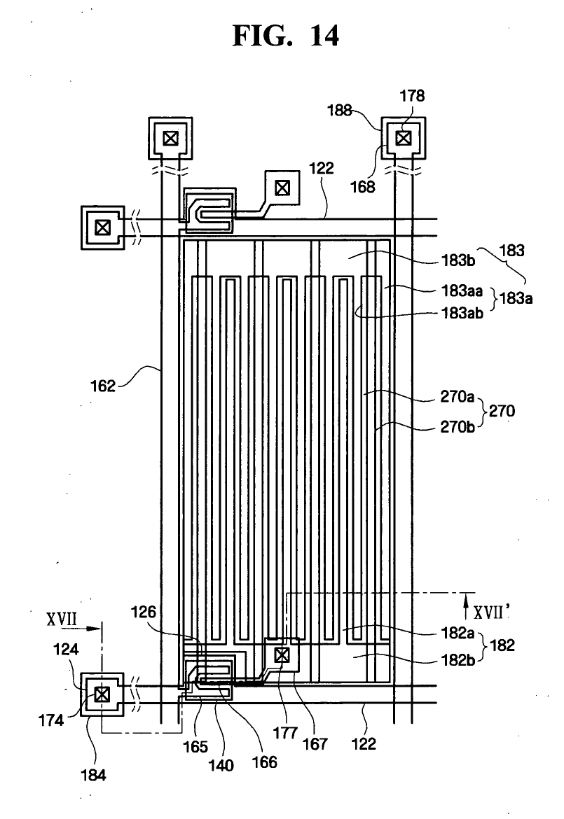

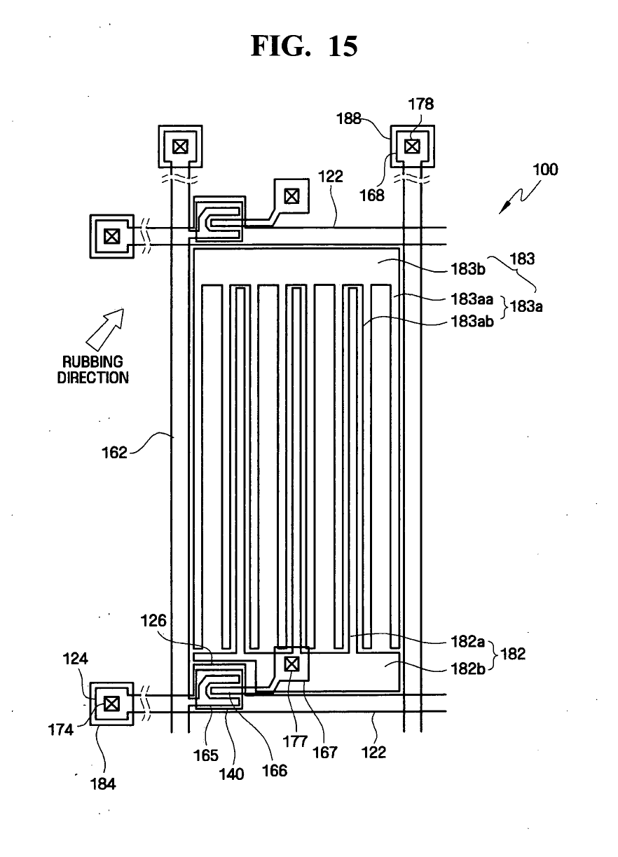

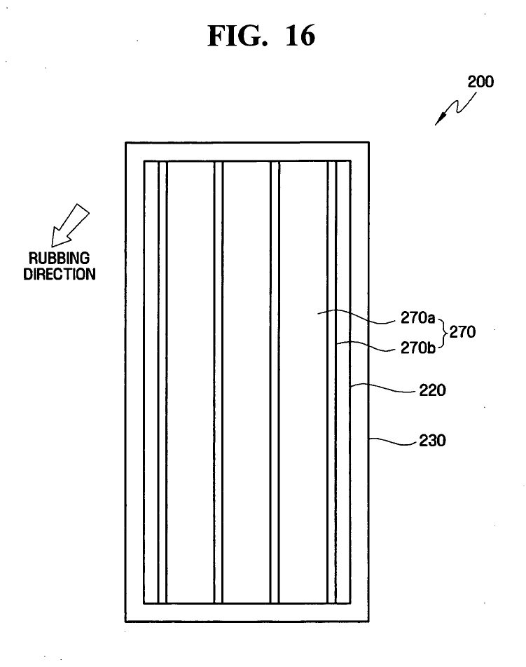

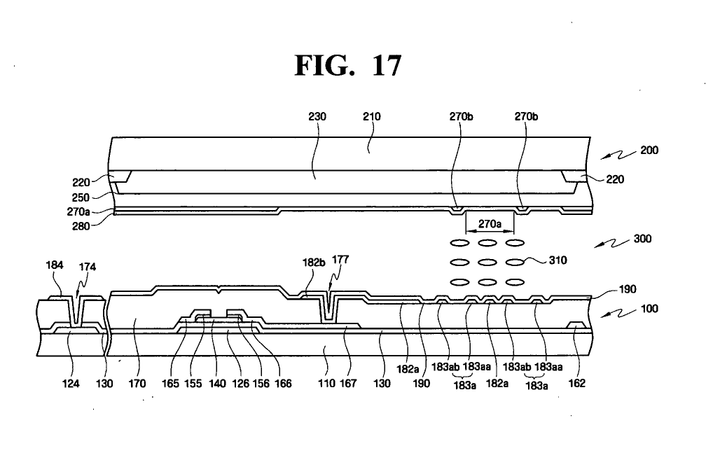

A liquid crystal display according to another embodiment of the present invention will now be described with reference to FIGS. 14 through 17. FIG. 14 is a layout view of a liquid crystal display according to another embodiment of the present invention, FIG. 15 is a layout view of a first plate 100 of the liquid crystal display according to an embodiment of the present invention, FIG. 16 is a layout view of a second plate of the liquid crystal display according to an embodiment of the present invention, and FIG. 17 is a sectional view taken along the line XVII-XVII′ of FIG. 14.

Since the liquid crystal display of this embodiment of the present invention is substantially the same as the liquid crystal display of the embodiment described in connection with FIGS. 1-4, only differences between the two embodiments are hereinafter described.

Referring to FIGS. 14, 15 and 17, with respect to the first plate 100, a pixel electrode 182 including a plurality of sub-electrodes 182a and a connection electrode 182b connecting the plurality of sub-electrodes 182a, and an additional electrode 183 forming a cross-finger structure together with the pixel electrode 182 are formed on a passivation layer 170. The additional electrode 183 includes a plurality of sub-electrodes 183a and connection electrodes connecting sub-electrodes 183a, and each of the plurality of sub-electrodes 183a may be composed of a plurality of sub-branch electrodes 183aa and. 183ab.

Each of the plurality of sub-branch electrodes 183aa and 183ab may have a predetermined shape, e.g., a stripe, parallel to the long side of a pixel area. The width of each of the sub-branch electrodes 183aa and 183bb and a gap between the sub-branch electrodes 183aa and 183bb are determined by the optical properties of the liquid crystal display. For example, the width of each of the sub-branch electrodes 183aa and 183ab may be about 7 μm or less, and a gap between the sub-branch electrodes 183aa and 183ab may be in a range of approximately 8 to approximately 20 μm. When the width of each of the sub-branch electrodes 183aa and 183ab is approximately 4 μm, the gap between the sub-branch electrodes 183aa and 183ab is approximately 9 μm.

A horizontal alignment film 190 is formed on a substrate 110 having thereon the pixel electrode 182 and the additional electrode 183 and rubbed at an angle of about 60 to 85 degrees with respect to the sub-electrodes 182a and 183a.

Referring to FIGS. 14, 16 and 17, with respect to the second plate 200, a common electrode 270 including a plurality of openings 270a and field-generating portions 270b is formed on an overcoat layer 250. Each of the openings 270a of the common electrode 270 and each of the sub-electrodes 182a of the pixel electrode 182 are positioned such that the sub-branch electrodes 183aa and 183ab belonging to two different sub-electrodes 183a are exposed. The field-generating portions between the openings 270a are located at a region defined between the sub-branch electrodes 183aa and 183ab belonging to the sub-electrode 183a of the same additional electrode 183.

The widths of the openings 270a are determined by the optical properties of the liquid crystal display and the widths of the sub-branch electrodes 183aa and 183ab. For example, the width of each of the openings 270a may be about 8 to 20 μm. When a width of each of the sub-branch electrodes 183aa and 183ab is 4 μm, the width of each of the openings 270a may be about 9 μm. The widths of the field-generating portions 270b of the common electrode 270 are determined by the optical properties of the liquid crystal display and the widths of the sub-branch electrodes 183aa and 183ab and the openings 270a. For example, the width of each of the field-generating portions 270b may be about 7 μm or less.

A horizontal alignment film 280 is formed on a substrate 210 having thereon the common electrode 270, and rubbed at an angle of about 60 to 85 degrees with respect to the openings 270a.

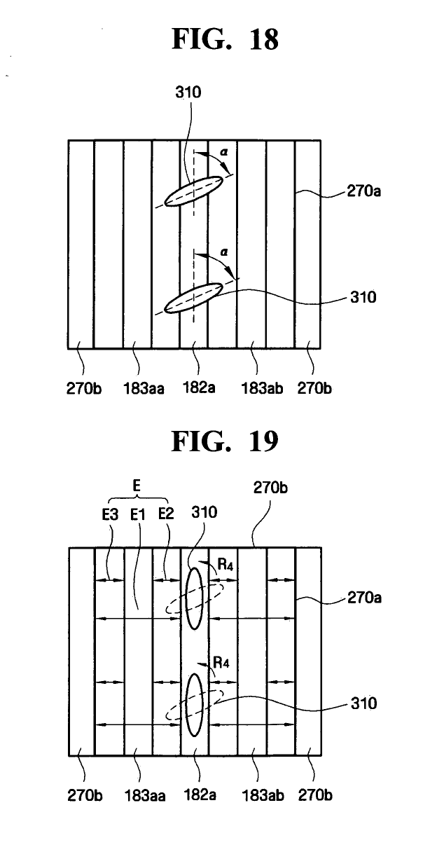

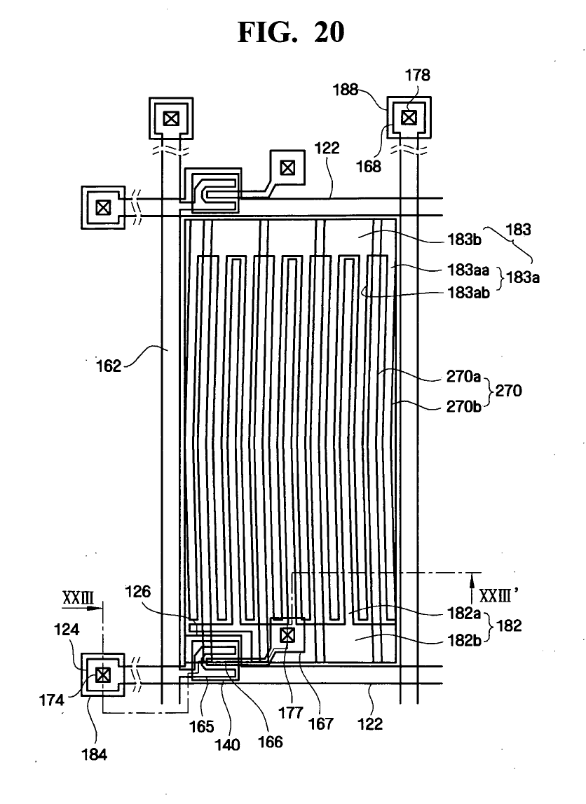

Next, the arrangement of liquid crystal molecules in the ON/OFF state of a thin film transistor of the liquid crystal display according to an embodiment of the present invention will now be described with reference to FIGS. 17 through 19. FIG. 18 is a schematic plan view illustrating the arrangement of liquid crystal molecules when the thin film transistor of the liquid crystal display according to an embodiment of the present invention is in an “OFF” state, and FIG. 19 is a schematic plan view illustrating the arrangement of liquid crystal molecules when the thin film transistor of the liquid crystal display according to an embodiment of the present invention is in an “ON” state.

First, with respect to liquid crystal molecule arrangement in an “OFF” state thin film transistor, referring to FIGS. 17 and 18, the long axes of liquid crystal molecules 310 are inclined parallel to the rubbing direction of the alignment films 190 and 280 of the first and second plate 200s, i.e., at an angle of about 60 to 85 degrees with respect to the sub-electrodes 182a and 183a. That is, the long axes of the liquid crystal molecules 310 have a tilt angle α of about 60 to 85 degrees with respect to the sub-electrodes 182a and 183a.

Next, with respect to liquid crystal molecule arrangement in an “ON” state thin film transistor, referring to FIGS. 17 and 19, when the thin film transistor is turned-on and an image signal is applied to the pixel electrode 182, the electric field E is generated between the first plate 100 and the second plate 200. Voltage conditions applied to the pixel electrode 182, the additional electrode 183, and the common electrode 270 are substantially the same as those in the liquid crystal display according to an embodiment of the present invention.

The electric field E generated between the first plate 100 and the second plate 200 is the vector summation of the electric field E1 between the sub-electrodes 182a of the pixel electrode 182 and the field-generating portions 270b of the common electrode 270, the electric field E2 between the sub-electrodes 182a of the pixel electrode 182 and the sub-branch electrodes 183aa or 183ab of the additional electrode 183, and an electric field E3 between the sub-branch electrodes 183aa or 183ab of the additional electrode 183 and the field-generating portions 270b of the common electrode 270.

The field-generating portions 270b of the common electrode 270, the sub-electrodes 182a of the pixel electrode 182 and the sub-branch electrodes 183a a and 183b b of the additional electrode 183 are alternately formed, with the liquid crystal layer 300 being interposed therebetween. Thus, the electric field E1 between the sub-electrodes 182a of the pixel electrode 182 and the field-generating portions 270b of the common electrode 270, and the electric field E2 between the sub-electrodes 182a of the pixel electrode 182 and the sub-branch electrodes 183aa or 183ab of the additional electrode 183 are not perpendicular or parallel but curved.

Furthermore, since the sub-electrodes 182a of the pixel electrode 182 and the sub-branch electrodes 183aa and 183ab of the additional electrode 183 are positioned on the same plane, the electric field E2 is generated as a relatively strong horizontal electric field.

The arrangement of the liquid crystal molecules 310 is determined by the vector summation of .the electric field E1 between the pixel electrode 182 and the common electrode 270, the electric field E2 between the pixel electrode 182 and the additional electrode 183, and the electric field E3 between the additional electrode 183 and the common electrode 270. As described above in the liquid crystal display according to an embodiment of the present invention, the liquid crystal molecules 310 having negative dielectric anisotropy are rotated in the direction of R₄ such that their long axes are perpendicular with respect to the field generating direction.

As described above, the liquid crystal display according to an embodiment of the present invention includes an additional electrode having sub-branch electrodes, so that a horizontal electric field is further produced between a common electrode and the additional electrode, thereby enhancing the horizontal electric field and improving transmittance.

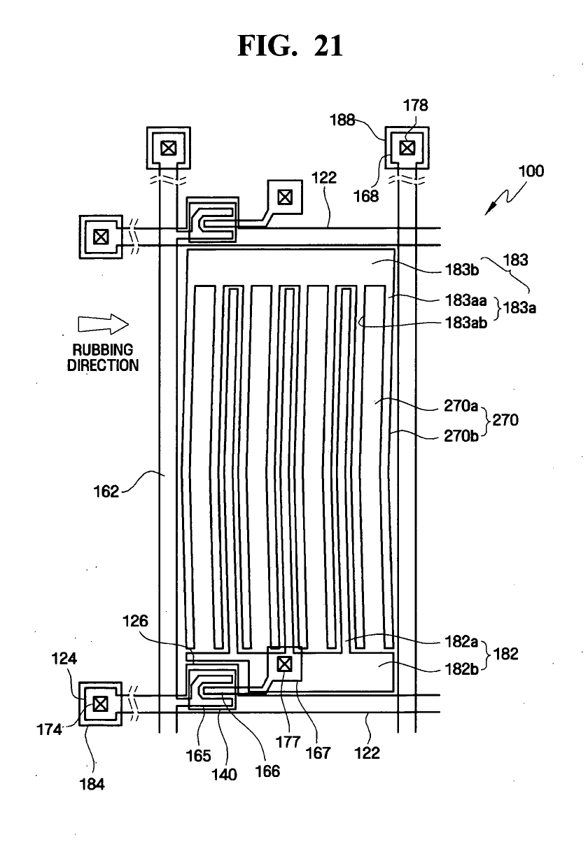

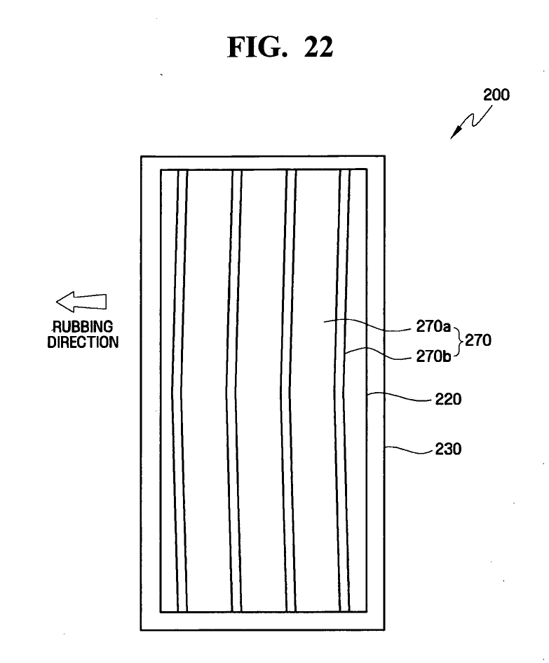

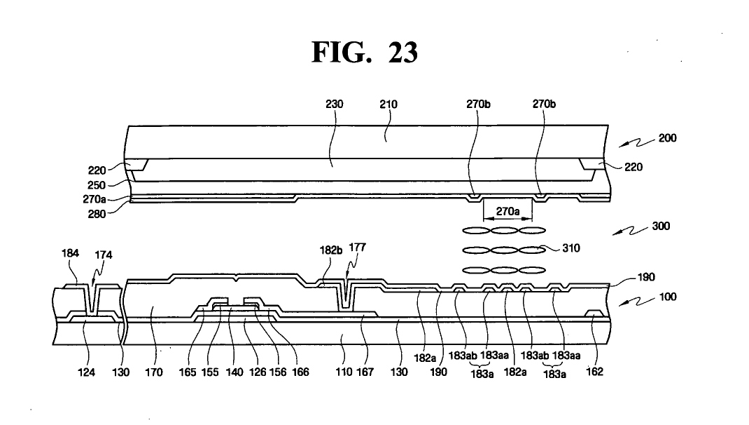

A liquid crystal display according to another embodiment of the present invention will now be described with reference to FIGS. 20 through 23. FIG. 20 is a layout view of a liquid crystal display according to another embodiment of the present invention, FIG. 21 is a layout view of a first plate of the liquid crystal display according to an embodiment of the present invention, FIG. 22 is a layout view of a second plate of the liquid crystal display according to an embodiment of the present invention, and FIG. 23 is a sectional view taken along the line XXIII-XXIII′ of FIG. 20.

Since the liquid crystal display of this embodiment of the present invention is substantially the same as the liquid crystal display of the embodiment described in connection with FIGS. 8-11 only differences between the two embodiments are hereinafter described.

Referring to FIGS. 20 through 23, alignment films 190 and 280 of the first and second plate 200s are rubbed at an angle of about 90 degrees with respect to the long side of a pixel area, respectively, under the condition that the rubbing direction of the alignment film 190 and the rubbing direction of the alignment film 280 form an angle of about 180 degrees.

Sub-electrodes 182a of a pixel electrode 182 and sub-branch electrodes 183aa and 183ab of sub-electrodes 183a of an additional electrode 183 which are disposed below the alignment film 190 of the first plate 100, and openings 270a of a common electrode 270 disposed below the alignment film 280 of the second plate 200 are disposed symmetrically with respect to the transverse centerline of the pixel area and are neither perpendicular nor parallel to the transverse centerline of the pixel area.

The sub-electrodes 182a of the pixel electrode 182, the sub-branch electrodes 183aa and 183ab of the sub-electrodes 183a of the additional electrode 183, and the openings 270a of the common electrode 270 are inclined at a predetermined angle with respect to the rubbing direction of the alignment film 190. That is, the sub-electrodes 182a of the pixel electrode 182, the sub-branch electrodes 183aa and 183ab of the sub-electrodes 183a of the additional electrode 183, and the openings 270a of the common electrode 270 in an upper pixel area positioned above the transverse centerline of the pixel area may be arranged parallel to each other in a state in which they are inclined at an angle of about 60 to 85 degrees with respect to the rubbing direction of the alignment film 190. The sub-electrodes 182a positioned in a lower pixel area, the sub-branch electrodes 183aa and 183ab and the openings 270a are arranged parallel to each other.

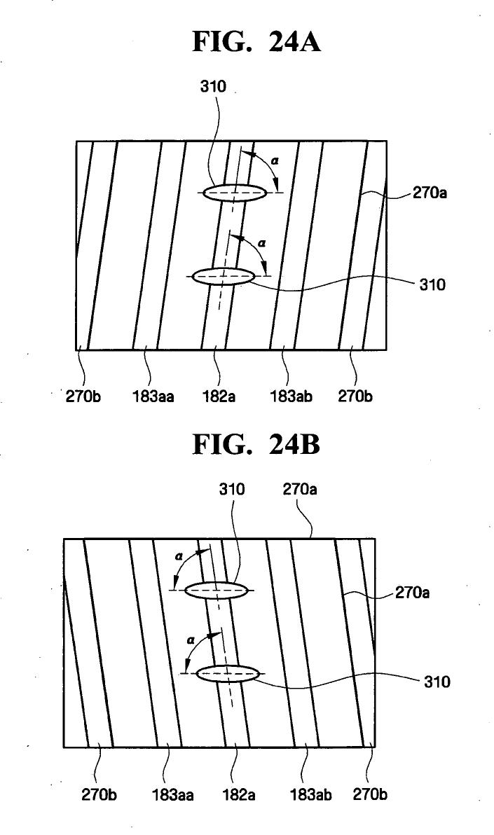

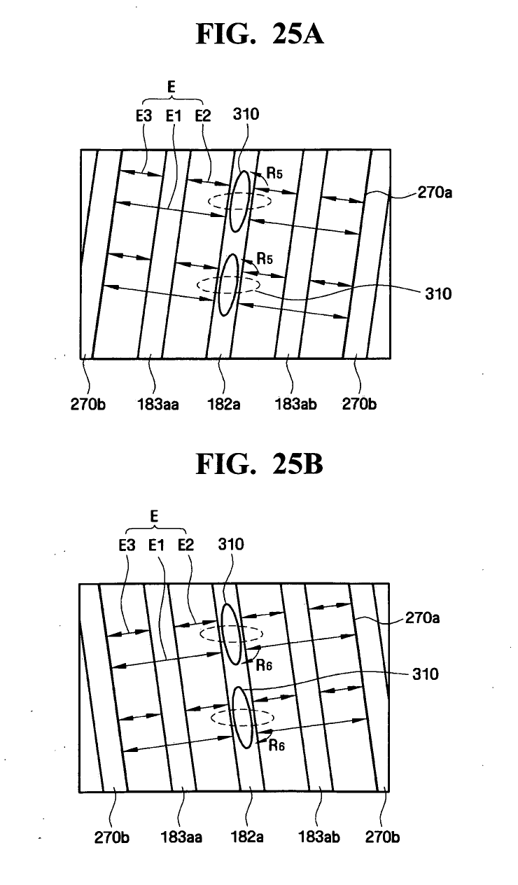

Next, the arrangement of liquid crystal molecules in the ON/OFF state of the thin film transistor of the liquid crystal display according to an embodiment of the present invention will now be described with reference to FIGS. 23 through 25B. FIGS. 24A and 24B are schematic plan views illustrating the arrangement of liquid crystal molecules when the thin film transistor of the liquid crystal display according to an embodiment of the present invention is in an “OFF” state, and FIGS. 25A and 25B are schematic plan views illustrating the arrangement of liquid crystal molecules when the thin film transistor of the liquid crystal display according to an embodiment of the present invention is in an “ON” state.

First, with respect to liquid crystal molecule arrangement in an “OFF” state thin film transistor, referring to FIGS. 23 through 24B, the long axes of liquid crystal molecules 310 are inclined parallel to the rubbing direction of the alignment films 190 and 280 of the first plate 100 and the second plate 200, i.e., at an angle of about 90 degrees with respect to the long side of the pixel area. That is, the liquid crystal molecules 310 in the upper pixel area positioned above the transverse centerline of the pixel area may have a tilt angle α of about 60 to 85 degrees with respect to the sub-electrodes 182a and 183a, as shown in FIG. 24A. The liquid crystal molecules 310 in the lower pixel area positioned below the transverse centerline of the pixel area may have a tilt angle a of about 60 to 85 degrees with respect to the sub-electrodes 182a and 183a and are arranged symmetrically with respect to sub electrodes 182a and 183a, as shown in FIG. 24B.

Next, with respect to liquid crystal molecule arrangement in an “ON” state thin film transistor, referring to FIGS. 23 and 25A-25B, when the thin film transistor is turned-on and an image signal is applied to the pixel electrode 182, the electric field E is generated between the first plate 100 and the second plate 200.

The arrangement of the liquid crystal molecules 310 is determined by the vector summation of the electric field E1 between the sub-electrodes 182a of the pixel electrode 182 and field-generating portions 270b of the common electrode 270, the electric field E2 between the sub-electrodes 182a of the pixel electrode 182 and the sub-branch electrodes 183aa or 183ab of the additional electrode 183, and the electric field E3 between the sub-branch electrodes 183aa or 183ab of the additional electrode 183 and the field-generating portions 270b of the common electrode 270. Thus, the liquid crystal molecules 310 negative dielectric anisotropy are rotated in the direction of R₅ (FIG. 25A) or R₆ (FIG. 25B) such that their long axes are perpendicular to the field generating direction.

As described above, the liquid crystal display according to an embodiment of the present invention has sub-electrodes and openings disposed symmetrically with respect to and neither perpendicular nor parallel to the transverse centerline of a pixel area, thereby improving a viewing angle and avoiding the occurrence of a rubbing angle error that may be caused when alignment films are rubbed.

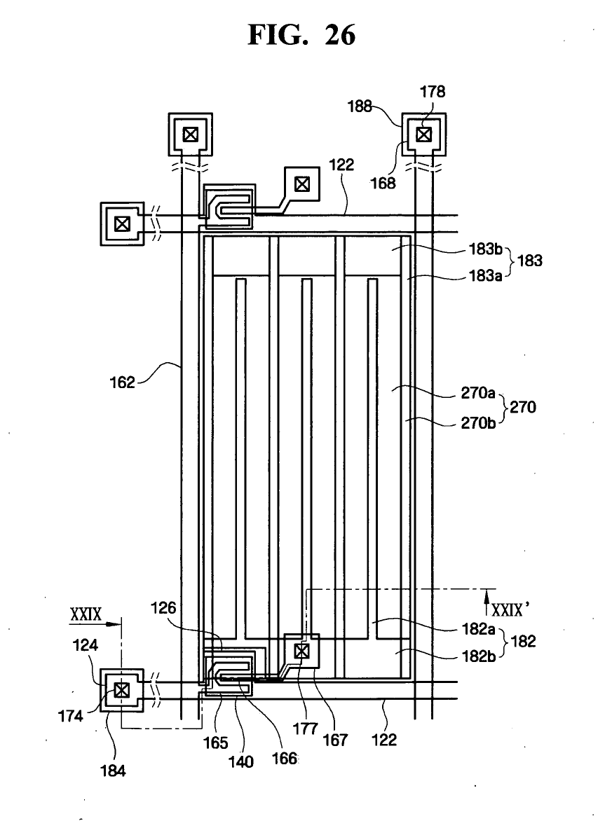

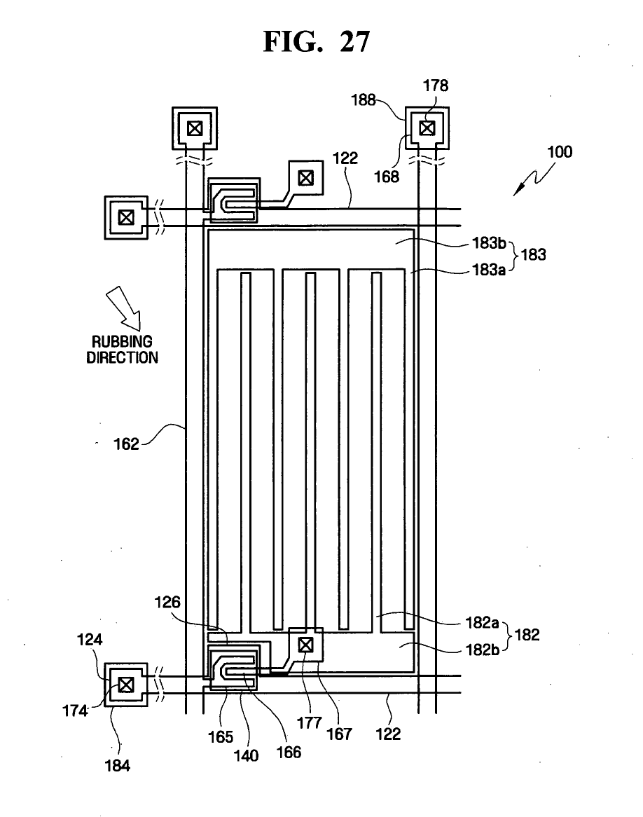

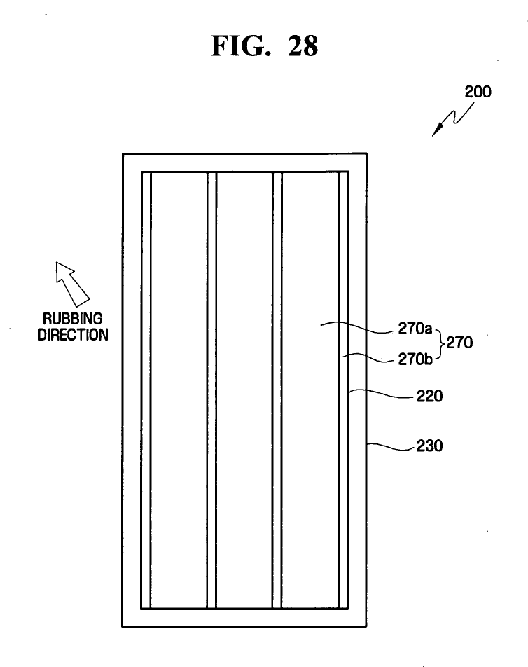

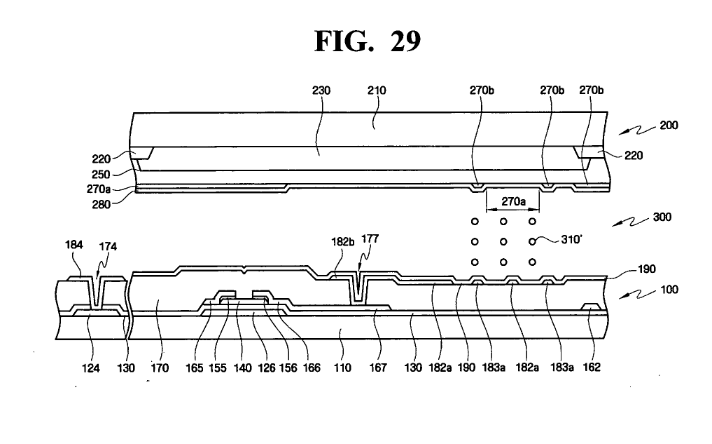

A liquid crystal display according to another embodiment of the present invention will now be described with reference to FIGS. 26 through 29. FIG. 26 is a layout view of a liquid crystal display according to another embodiment of the present invention, FIG. 27 is a layout view of a first plate of the liquid crystal display according to an embodiment of the present invention, FIG. 28 is a layout view of a second plate of the liquid crystal display according to an embodiment of the present invention, and FIG. 29 is a sectional view taken along the line XXIX-XXIX′ of FIG. 26.

Since the liquid crystal display of this embodiment of the present invention is substantially the same as the liquid crystal display of the embodiment described in connection with FIGS. 1-4, only differences between the two embodiments are hereinafter described.

Referring to FIGS. 26, 27 and 29, with respect to the first plate 100, a pixel electrode 182 including a plurality of sub-electrodes 182a and a connection electrode 182b connecting the sub-electrodes 182a, and an additional electrode 183 including a plurality of sub-electrodes 183a and a connection electrode 183b and forming a cross-finger structure together with the pixel electrode 182 are formed on a passivation layer 170. The sub-electrodes 182a and 183a may have a predetermined stripe shape parallel to the long side of a pixel area.

The width and gap of the sub-electrodes 182a and 183a are determined by optical properties of the liquid crystal display. The width of each of the sub-electrodes 182a and 183a may be about 7 μm, and a gap between the sub-electrodes 182a or 183a may be about 20 to 40 μm. For example, when the width of each of the sub-electrodes 182a is approximately 4 μm, a gap between the sub-electrodes 182a may be approximately 36 μm.

As described above, the connection electrodes 182b and 183b of the pixel electrode 182 and the additional electrode 183 electrically connect the sub-electrodes 182a and 183a, respectively. For example, the connection electrodes 182b and 183b may be connected to at least one of both ends of the sub-electrodes 182a and 183a, respectively. Alternatively, the connection electrodes 182b and 183b may also be connected to the central portions of the sub-electrodes 182a and 183a, respectively. However, the present invention is not limited to the illustrated examples.

An alignment film 190 is formed on a substrate 110 having thereon the pixel electrode 182 and the additional electrode 183. The alignment film 190 is a horizontal alignment film that allows liquid crystal molecules 310′ to be aligned horizontally with respect to the surface of the substrate 110 in a voltage-off state. For example, the alignment film 190 may be a surface-treated alignment film that allows the liquid crystal molecules 310′ to have a pretilt angle of about 0.5 to 3 degrees with respect to the surface of the substrate 110. The alignment film 190 is rubbed so that the liquid crystal molecules 310′ of a liquid crystal layer 300 are inclined at a predetermined angle with respect to the sub-electrodes 182a and 183a in a voltage-off state. The predetermined angle is determined by the optical properties of the liquid crystal display, and may be an arbitrary angle other than 0 and 90 degrees, e.g., about 5 to 30 degrees.

Referring to FIGS. 26, 28 and 29, with respect to the second plate 200, a common electrode 270 including a plurality of openings 270a and field-generating portions 270b is formed on an overcoat layer 250. The sub-electrodes 182a of the pixel electrode 182 are exposed through the openings 270a of the common electrode 270, with the liquid crystal layer 300 being interposed therebetween, and the field-generating portions 270b between the openings 270a overlap with the sub-electrodes 183a of the additional electrode 183.

The widths of the openings 270a are determined by the optical properties of the liquid crystal display and the widths of the sub-electrodes 182a and 183a.

The width of each of the openings 270a may be about 20 to 40 μm. For example, when the width of each of the sub-electrodes 182a is 4 μm, the width of each of the openings 270a may be about 36 μm.

In addition, the widths of the field-generating portions 270b of the common electrode 270 are determined by the optical properties of the liquid crystal display and the widths of the sub-electrodes 182a and 183a and the openings 270a. The width of each of the field-generating portions 270b may be about 7 μm.

An alignment film 280 is formed on a substrate 210 having thereon the common electrode 270. The alignment film 280 is rubbed at substantially the same angle as the alignment film 190 under the condition that the rubbing direction of the alignment film 190 and the rubbing direction of the alignment film 280 form an angle of about 180 degrees.

In addition, the liquid crystal molecules 310′ of the liquid crystal layer 300 have positive dielectric anisotropy (Δε>0), i.e., the long axes of the liquid crystal molecules 310′ are aligned horizontally with respect to an applied electric field.

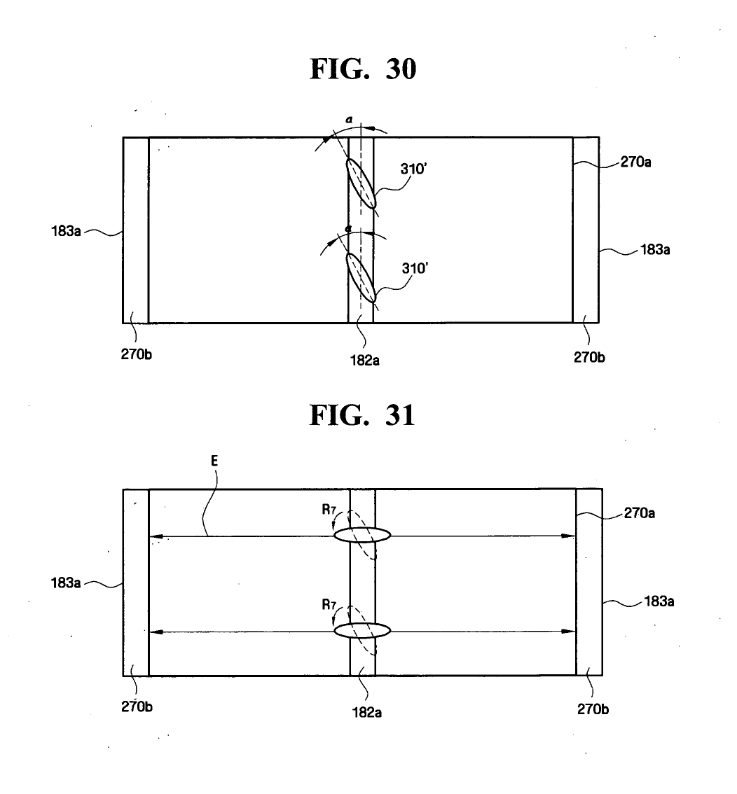

Next, the arrangement of liquid crystal molecules in the ON/OFF state of the thin film transistor of the liquid crystal display according to an embodiment of the present invention will now be described with reference to FIGS. 29 through 31. FIG. 30 is a schematic plan view illustrating the arrangement of liquid crystal molecules when the thin film transistor of the liquid crystal display according to an embodiment of the present invention is in an “OFF” state, and FIG. 31 is a schematic plan view illustrating the arrangement of liquid crystal molecules when the thin film transistor of the liquid crystal display according to an embodiment of the present invention is in an “ON” state.

First, with respect to liquid crystal molecule arrangement in an “OFF” state thin film transistor, referring to FIGS. 29 and 30, the long axes of the liquid crystal molecules 310′ are inclined parallel to the rubbing direction of the alignment films 190 and 280 of the first plate 100 and the second plate 200, i.e., at an angle of about 5 to 30 degrees with respect to the sub-electrodes 182a and 183a. That is, the long axes of the liquid crystal molecules 310′ have a tilt angle a of about 5 to 30 degrees with respect to the sub-electrodes 182a and 183b.

Next, with respect to liquid crystal molecule arrangement in an “ON” state thin film transistor, referring to FIGS. 29 and 31, when the thin film transistor is turned-on and an image signal is applied to the pixel electrode 182, the electric field E is generated between the first plate 100 and the second plate 200. A voltage applied to the additional electrode 183 may be equal to or greater than a voltage applied to the common electrode 270 and smaller than the voltage applied to the pixel electrode 182. For example, when voltages of 0V and 7V are respectively applied to the common electrode 270 and the pixel electrode 182, a voltage of about 0-2V may be applied to the additional electrode 183, but the present invention is not limited thereto.

In the same manner as in the “ON” state of the thin film transistor of the liquid crystal display according to an embodiment of the present invention, the arrangement of the liquid crystal molecules 310′ is determined by the vector summation of the electric field between the sub-electrodes 182a of the pixel electrode 182 and the field-generating portions 270b of the common electrode 270, the electric field between the sub-electrodes 182a of the pixel electrode 182 and the sub-electrodes 183a of the additional electrode 183, and the electric field between the sub-electrodes 183a of the additional electrode 183 and the field-generating portions 270b of the common electrode 270. Thus, the liquid crystal molecules 310′ having positive dielectric anisotropy are rotated in the direction of R₇ such that their long axes are parallel to the field generating direction. The rotation angle of the liquid crystal molecules 310′ having positive dielectric anisotropy is greater than that of liquid crystal molecules having negative dielectric anisotropy.

As described above, the liquid crystal display according to an embodiment of the present invention has a gap between sub-electrodes and a width of each of openings of a common′ electrode wider than those of the corresponding elements in the embodiment shown in FIGS. 1-4, so that no electric field distortion is generated even when a misalignment occurs between the first plate 100 and the second plate 200. Furthermore, the use of liquid. crystal molecules having positive dielectric anisotropy increases a response speed and in-plane movement, thereby ensuring improved transmittancean embodiment.

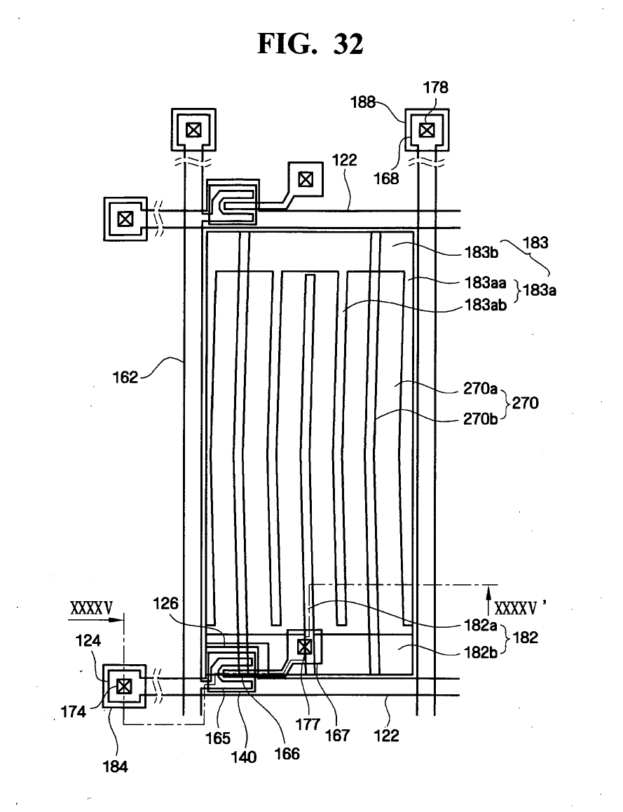

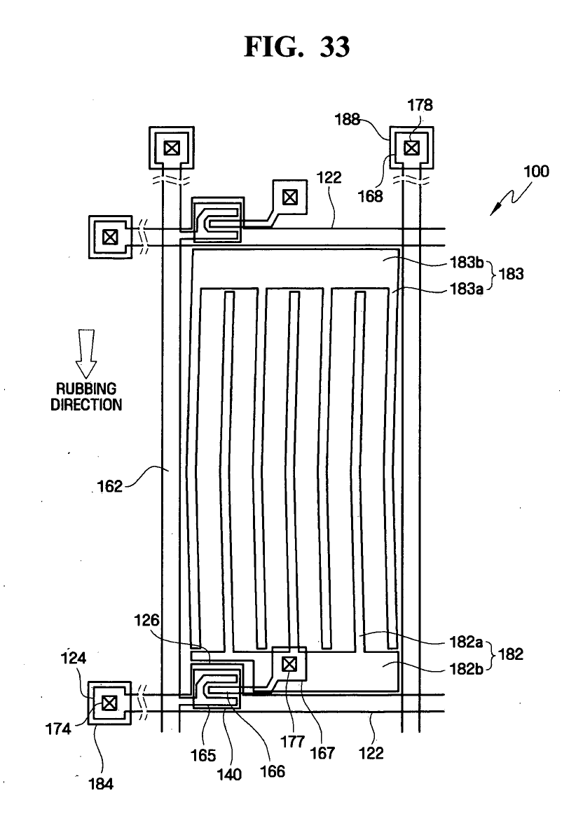

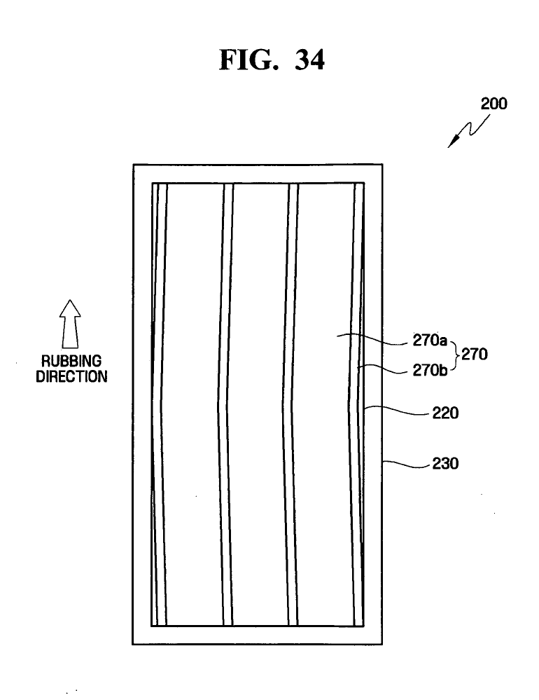

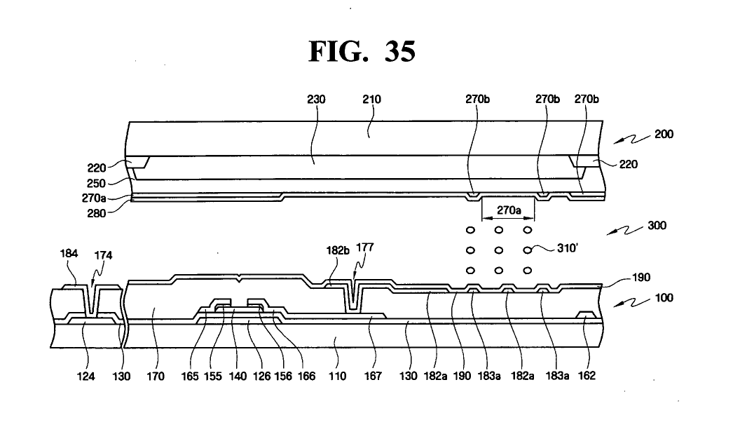

A liquid crystal display according to another embodiment of the present invention will now be described with reference to FIGS. 32 through 35. FIG. 32 is a layout view of a liquid crystal display according to another embodiment of the present invention, FIG. 33 is a layout view of a first plate of the liquid crystal display according to an embodiment of the present invention, FIG. 34 is a layout view of a second plate of the liquid crystal display according to an embodiment of the present invention, and FIG. 35 is a sectional view taken along the line XXXV-XXXV′ of FIG. 32.

Since the liquid crystal display of this embodiment of the present invention is substantially the same as the liquid crystal display of the embodiment described in connection with FIGS. 26-29, only differences between the two embodiments are hereinafter described.

Referring to FIGS. 32 through 33, in the liquid crystal display of an embodiment of the present invention, an alignment film 190 of a first plate 100 is rubbed parallel to the long side of a pixel area and an alignment film 280 of a second plate 200 is rubbed parallel to the long side of a pixel area under the condition that the rubbing direction of the alignment film 190 and the rubbing direction of the alignment film 280 form an angle of about 180 degrees.

Sub-electrodes 182a and 183a of a pixel electrode 182 and an additional electrode 183 disposed below the alignment film 190 of the first plate 100 and openings 270a of a common electrode 270 disposed below the alignment film 280 of the second plate 200 are disposed symmetrically and are neither perpendicular nor parallel to the transverse centerline of the pixel area.

The sub-electrodes 182a and 183a and the openings 270a may be inclined at a predetermined angle with respect to the rubbing direction of the alignment film 190. That is, the sub-electrodes 182a and 183a and the openings 270a in an upper pixel area positioned above the transverse centerline of the pixel area may be arranged parallel to each other in a state in which they are inclined at an angle of about 5 to 30 degrees with respect to the rubbing direction of the alignment film 190. The sub-electrodes 182a and 183a and the openings 270a in a lower pixel area positioned below the transverse centerline of the pixel area may be arranged parallel to each other in a state in which they are inclined at an angle of about 5 to 30 degrees with respect to the rubbing direction of the alignment film 190 to be symmetric to the sub-electrodes 182a and 183a and the openings 270a in the upper pixel area.

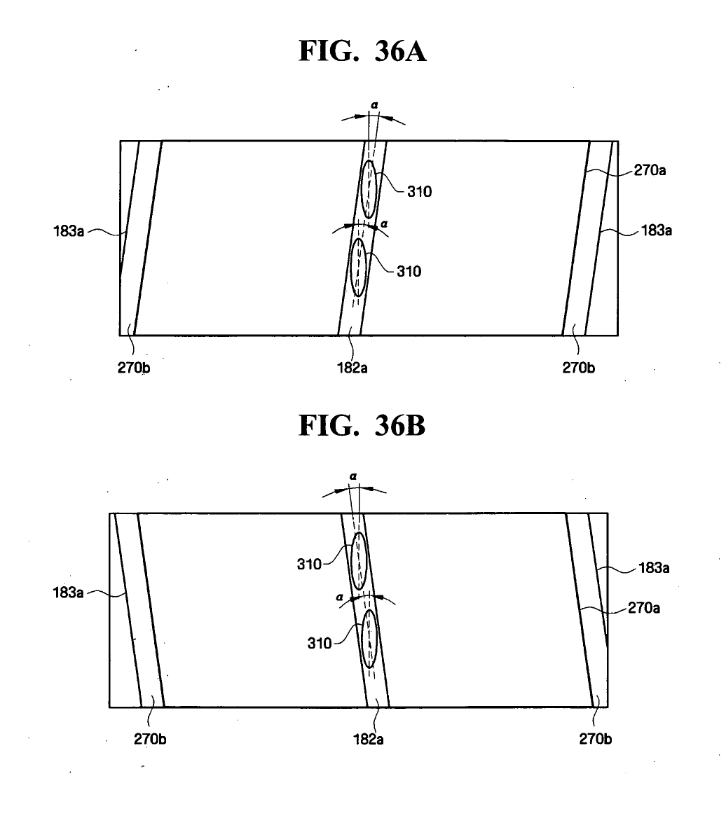

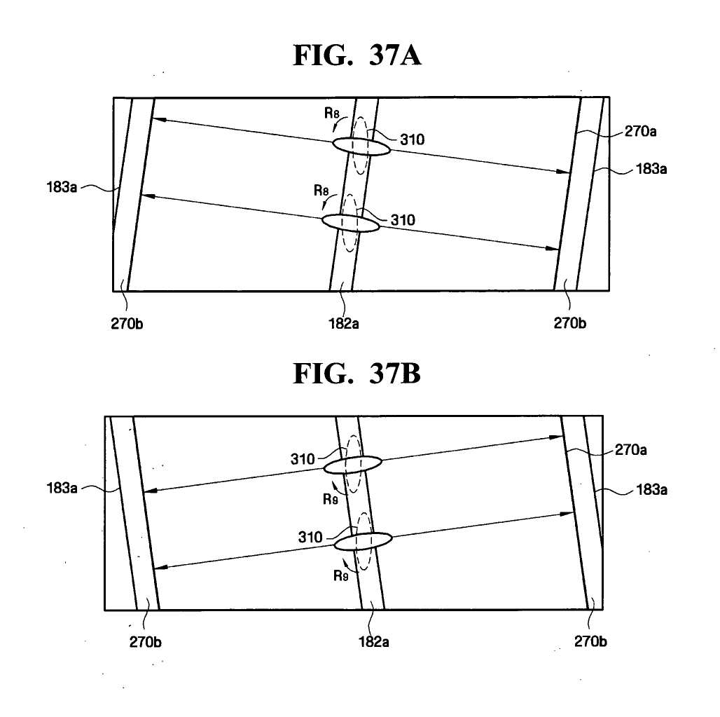

The arrangement of liquid crystal molecules in the ON/OFF state of a thin film transistor of the liquid crystal display according to an embodiment of the present invention will now be described with reference to FIGS. 35 through 37B. FIGS. 36A and 36B are schematic plan views illustrating the arrangement of liquid crystal molecules when the thin film transistor of the liquid crystal display according to an embodiment of the present invention is in an “OFF” state, and FIGS. 37A and 37B are schematic plan views illustrating the arrangement of liquid crystal molecules when the thin film transistor of the liquid crystal display according to an embodiment of the present invention is in an “ON” state.

First, with respect to the arrangement of liquid crystal molecules in an “OFF” state thin film transistor, referring to FIGS. 35 through 36B, the long axes of liquid crystal molecules 310′ are inclined parallel to the rubbing direction of the alignment films 190 and 280, i.e., to the long side of the pixel area. That is, the liquid crystal molecules 310′ in the upper pixel area positioned above the transverse centerline of the pixel area may have a tilt angle a of about 5 to 30 degrees with respect to the sub-electrodes 182a and 183a, as shown in FIG. 35A. The liquid crystal molecules 310′ in the lower pixel area positioned below the transverse centerline of the pixel area may be arranged symmetrically with respect to the sub-electrodes 182a and 183a, as shown in FIG. 35B.

Next, with respect to liquid crystal molecule arrangement in an “ON” state thin film transistor, referring to FIGS. 35 and 37A-37B, when the thin film transistor is turned-on and an image signal is applied to the pixel electrode 182, the electric field E is generated between the first plate 100 and the second plate 200.

In the same manner as in the “ON” state of the thin film transistor of the liquid crystal display according to an embodiment of the present invention, the arrangement of the liquid crystal molecules 310′ is determined by the vector summation of the electric field between the sub-electrodes 182a of the pixel electrode 182 and field-generating portions 270b of the common electrode 270, the electric field between the sub-electrodes 182a of the pixel electrode 182 and the sub-electrodes 183a of the additional electrode 183, and the electric field between the sub-electrodes 183a of the additional electrode 183 and the field-generating portions 270b of the common electrode 270. Thus, the liquid crystal molecules 310′ having positive dielectric anisotropy are rotated in the direction of R₈ (FIG. 37A) or R₉ (FIG. 37B) such that their long axes are parallel with respect to the field generating direction.

As described above, the liquid crystal display according to an embodiment of the present invention includes sub-electrodes and openings disposed symmetrically with respect to and neither perpendicular nor parallel to the transverse centerline of a pixel area, thereby improving a viewing angle and avoiding the occurrence of a rubbing angle error that may be caused when alignment films are rubbed.

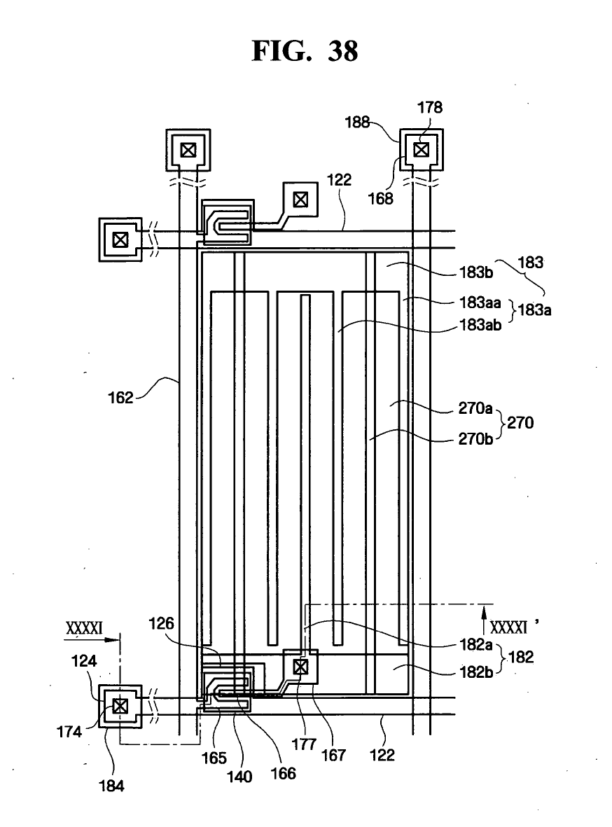

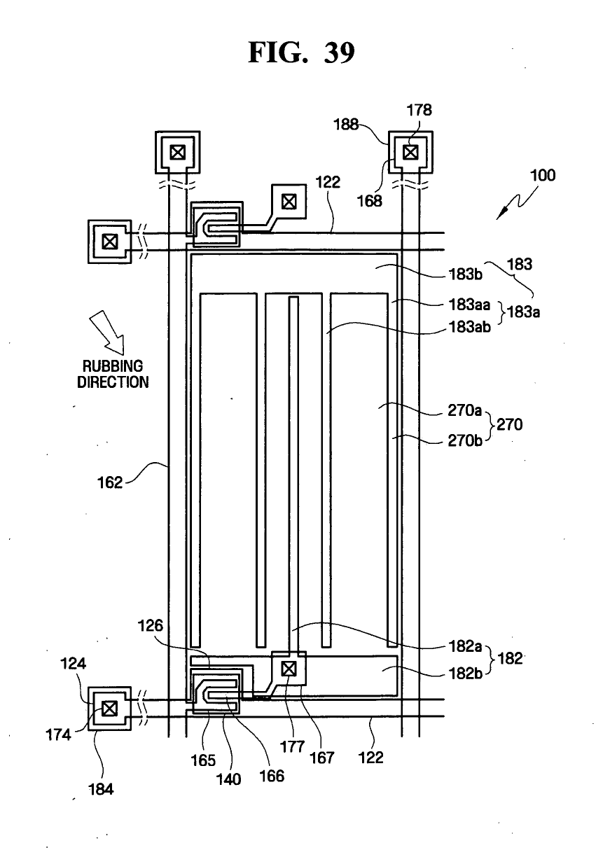

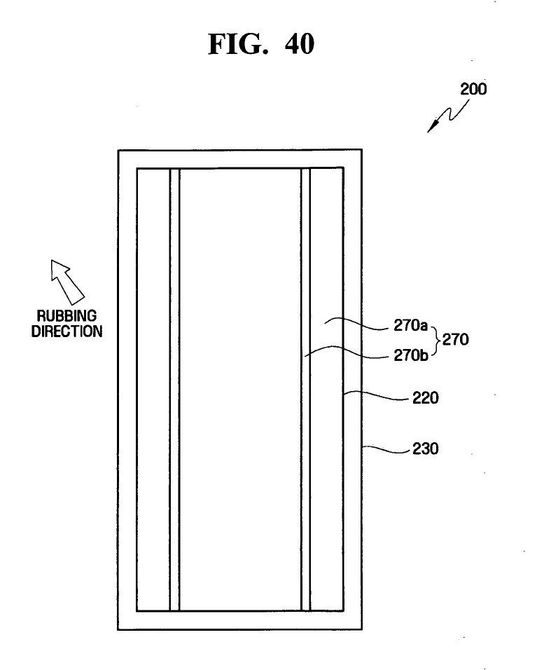

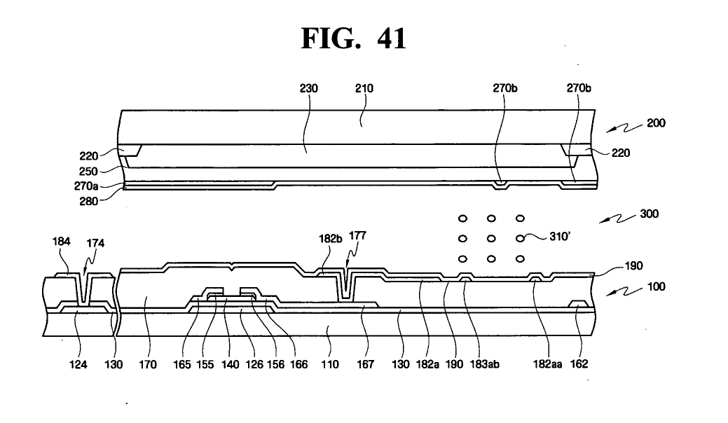

A liquid crystal display according to another embodiment of the present invention will now be described with reference to FIGS. 38 through 41. FIG. 38 is a layout view of a liquid crystal display according to another embodiment of the present invention, FIG. 39 is a layout view of a first plate of the liquid crystal display according to an embodiment of the present invention, FIG. 40 is a layout view of a second plate of the liquid crystal display according to an embodiment of the present invention, and FIG. 41 is a sectional view taken along the line XXXXI-XXXXI′ of FIG. 38.

Since the liquid crystal display of this embodiment of the present invention is substantially the same as the liquid crystal display of the embodiment described in connection with FIGS. 26-29, only differences between the two embodiments are hereinafter described.

Referring to FIGS. 38, 39 and 41, with respect to the first plate 100, a pixel electrode 182 including a plurality of sub-electrodes 182a and a connection electrode 182b connecting the sub-electrodes 182a, and an additional electrode 183 forming a cross-finger structure together with the pixel electrode 182 are formed on a passivation layer 170. The additional electrode 183 includes a plurality of sub-electrodes 183a and a connection electrode 183b connecting the sub-electrodes 183a. Each of the sub-electrodes 183a may be composed of a plurality of sub-branch electrodes 183aa and 183ab.

The sub-branch electrodes 183aa and 183ab constituting each of the sub-electrodes 183a of the additional electrode 183 may have a predetermined stripe shape parallel to the long side of a pixel area. The width of the sub-branch electrodes 183aa and 183ab and a gap between the sub-branch electrodes 183aa and 183ab are determined by the optical properties of the liquid crystal display. The width of each of the sub-branch electrodes 183aa and 183ab may be about 7 μm or less, and a gap between the sub-branch electrodes 183aa and 183ab may be about 20 to 40 μmn. For example, when the width of each of the sub-branch electrodes 183aa and 183ab is 4 μm, a gap between the sub-branch electrodes 183aa and 183ab may be about 34 μm.

A horizontal alignment film 190 is formed on a substrate 110 having thereon the pixel electrode 182 and the additional electrode 183 and rubbed at an angle of about 5 to 30 degrees with respect to the sub-electrodes 182a and 183a.

With respect to the second plate 200, a common electrode 270 including a plurality of openings 270a and field-generating portions 270b is formed on an overcoat layer 250. Each sub-electrode 182a of the pixel electrode 182, and sub-branch electrodes 183aa and 183ab, positioned at both sides of the sub-electrode 182a, respectively belonging to different two sub-electrodes 183a are exposed through each of openings 270a of the common electrode 270. Each of the field-generating portions 270b overlaps with a region defined between the sub-branch electrodes 183aa and 183ab of each of the sub-electrodes 183a.

The widths of the openings 270a are determined by the optical properties of the liquid crystal display and the widths of the sub-branch electrodes 183aa and 183ab. The width of each of the openings 270a may be about 20 to 40 μm. For example, when the width of each of the sub-branch electrodes 183aa and 183ab is 4 μm, the width of each of the openings 270a may be about 36 μm. The widths of the field-generating portions 270b of the common electrode 270 are determined by the optical properties of the liquid crystal display and the widths of the sub-branch electrodes 183aa and 183ab and the openings 270a. The width of each of the field-generating portions 270b may be about 7 μm or less.

A horizontal alignment film 280 is formed on a substrate 210 having thereon the common electrode 270, and rubbed at an angle of about 60 to 85 degrees with respect to the openings 270a.

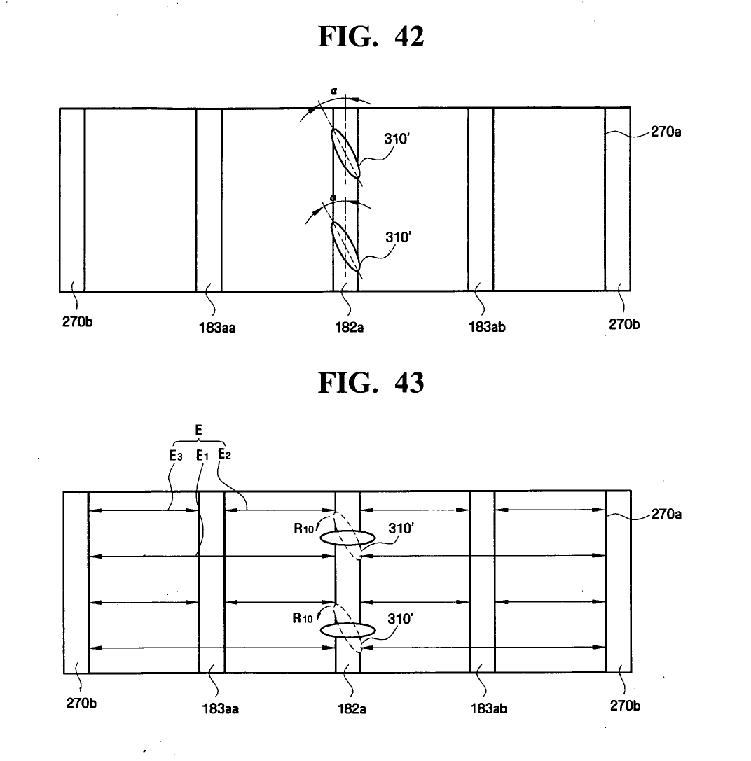

Next, the arrangement of liquid crystal molecules in the ON/OFF state of a thin film transistor of the liquid crystal display according to an embodiment of the present invention will now be described with reference to FIGS. 41 through 43. FIG. 42 is a schematic plan view illustrating the arrangement of liquid crystal molecules when the thin film transistor of the liquid crystal display according to an embodiment of the present invention is in an “OFF” state, and FIG. 43 is a schematic plan view illustrating the arrangement of liquid crystal molecules when the thin film transistor of the liquid crystal display according to an embodiment of the present invention is in an “ON” state.

First, with respect to the arrangement of liquid crystal molecules in an “OFF” state thin film transistor, referring to FIGS. 41 and 42, the long axes of liquid crystal molecules 310′ are inclined parallel to the rubbing direction of the alignment films 190 and 280 of the first plate 100 and the second plate 200, i.e., at an angle of about 5 to 30 degrees with respect to the sub-electrodes 182a and 183a. That is, the long axes of the liquid crystal molecules 310′ have a tilt angle a of about 5 to 30 degrees with respect to the sub-electrodes 182a and 183b.

Next, with respect to liquid crystal molecule arrangement in an “ON” state thin film transistor, referring to FIGS. 41 and 43, when the thin film transistor is turned-on and an image signal is applied to the pixel electrode 182, the electric field E is generated between the first plate 100 and the second plate 200.

The arrangement of the liquid crystal molecules 310′ is determined by the vector summation of the electric field E1 between the sub-electrodes 182a of the pixel electrode 182 and the field-generating portions 270b of the common electrode 270, the electric field E2 between the sub-electrodes 182a of the pixel electrode 182 and the sub-branch electrodes 183aa or 183ab of the additional electrode 183, and the electric field E3 between the sub-branch electrodes 183aa or 183ab of the additional electrode 183 and the field-generating portions 270b of the common electrode 270. Thus, the liquid crystal molecules 310′ having positive dielectric anisotropy are rotated in the direction of R₁₀ such that their long axes are perpendicular with respect to the field generating direction.

As described above, the liquid crystal display according to an embodiment of the present invention includes an additional electrode having sub-electrodes composed of sub-branch electrodes, so that a horizontal electric field is further produced between a common electrode and the additional electrode, thereby enhancing the horizontal electric field and improving transmittance.

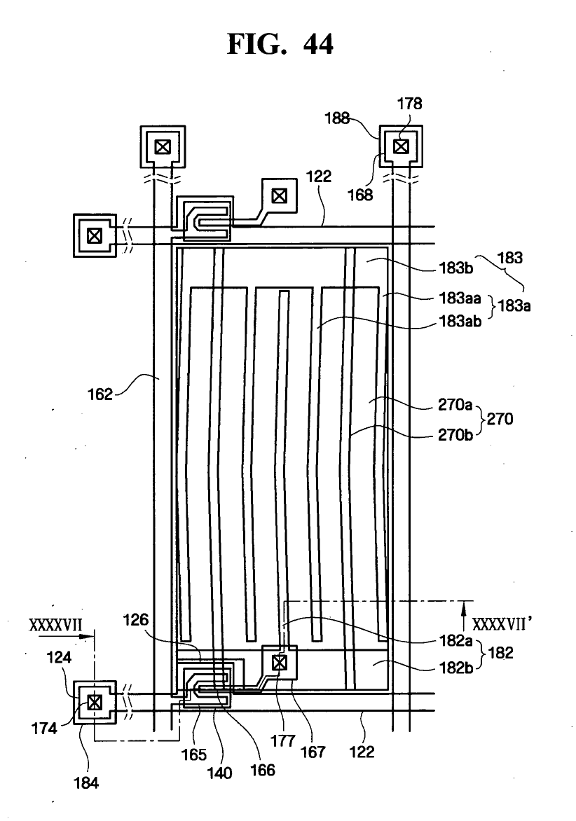

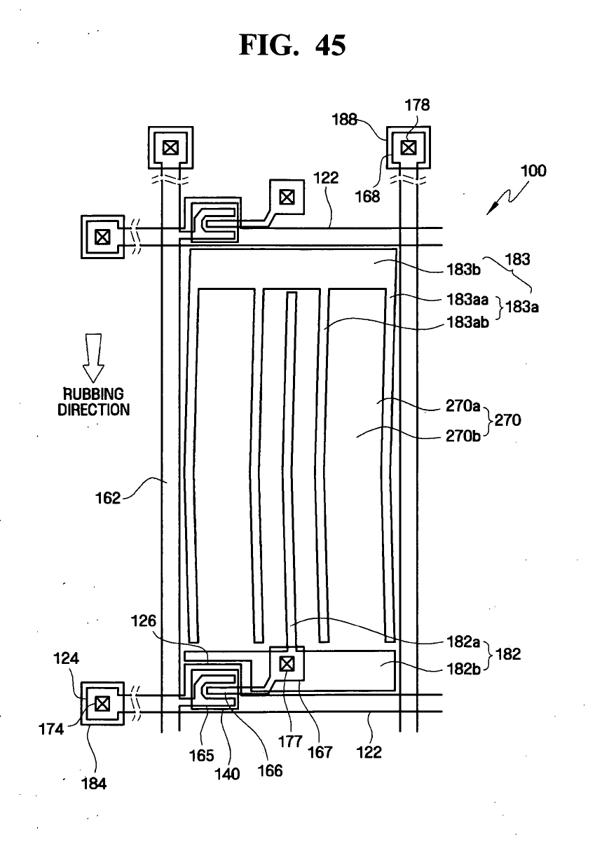

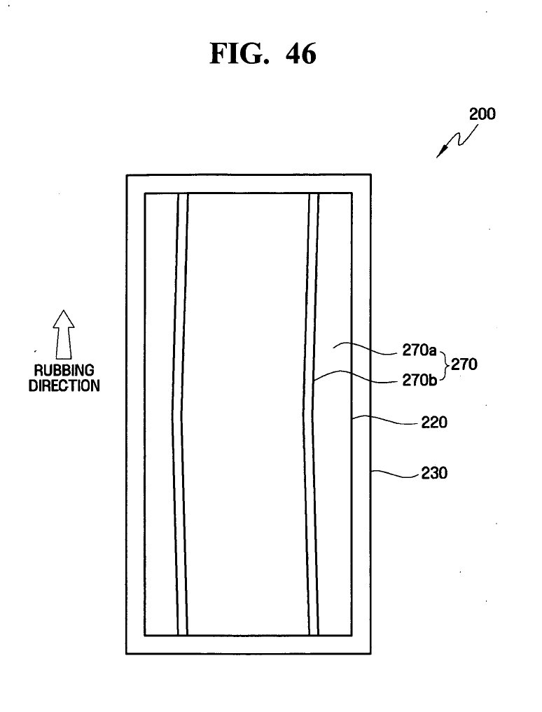

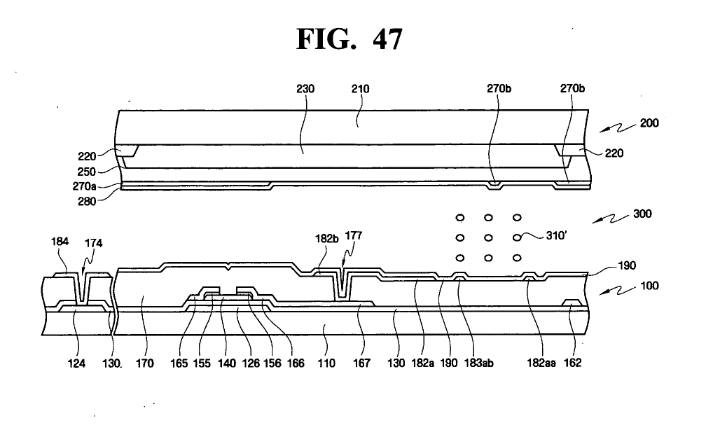

A liquid crystal display according to another embodiment of the present invention will now be described with reference to FIGS. 44 through 47. FIG. 45 is a layout view of a first plate of the liquid crystal display according to an embodiment of the present invention, FIG. 46 is a layout view of a second plate 200 of the liquid crystal display according to an embodiment of the present invention, and FIG. 47 is a sectional view taken along the line XXXXVII-XXXXVII′ of FIG. 44.

Referring to FIGS. 44 through 47, since the liquid crystal display of this embodiment of the present invention is the same as the liquid crystal display of the embodiment described in connection with FIGS. 38-41, only differences between the two embodiments are hereinafter described.

An alignment film 190 of a first plate 100 and an alignment film 280 of a second plate 200 are rubbed parallel to the long side of a pixel area under the condition that the rubbing direction of the alignment film 190 and the rubbing direction of the alignment film 280 forms an angle of about 180 degrees.

Sub-electrodes 182a of a pixel electrode 182, and sub-branch electrodes 183aa and 183ab constituting each of sub-electrodes 183a of an additional electrode 183, which are disposed below the alignment film 190 of the first plate 100, and openings 270a of a common electrode 270 disposed below the alignment film 280 of the second plate 200 are disposed symmetrically with respect to and neither perpendicular nor parallel to the transverse centerline of the pixel area.

The sub-electrodes 182a of the pixel electrode 182, the sub-branch electrodes 183aa and 183ab of the sub-electrodes 183a of the additional electrode 183, and the openings 270a may be inclined at a predetermined angle with respect to the rubbing direction of the alignment film 190. That is, the sub-electrodes 182a of the pixel electrode 182, the sub-branch electrodes 183aa and 183ab of the sub-electrodes 183a of the additional electrode 183, and the openings 270a in an upper pixel area positioned above the transverse centerline of the pixel area may be arranged parallel to each other in a state in which they are inclined at an angle of about 5 to 30 degrees with respect to the rubbing direction of the alignment film 190. The sub-electrodes 182a in a lower pixel area positioned below the transverse centerline of the pixel area, the sub-branch electrodes 183aa and 183ab, and the openings 270a may be arranged symmetrically to the sub-electrodes 182a in an upper pixel area, the sub-branch electrodes 183aa and 183ab, and the openings 270a.

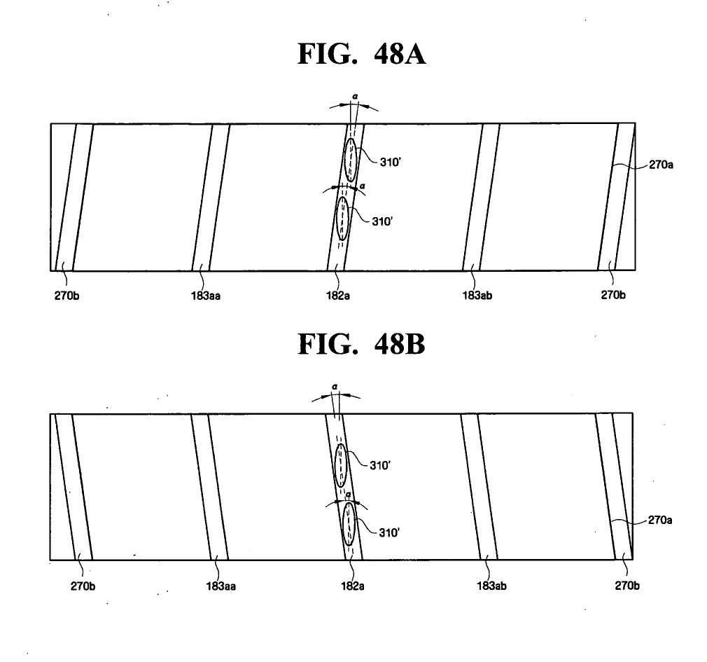

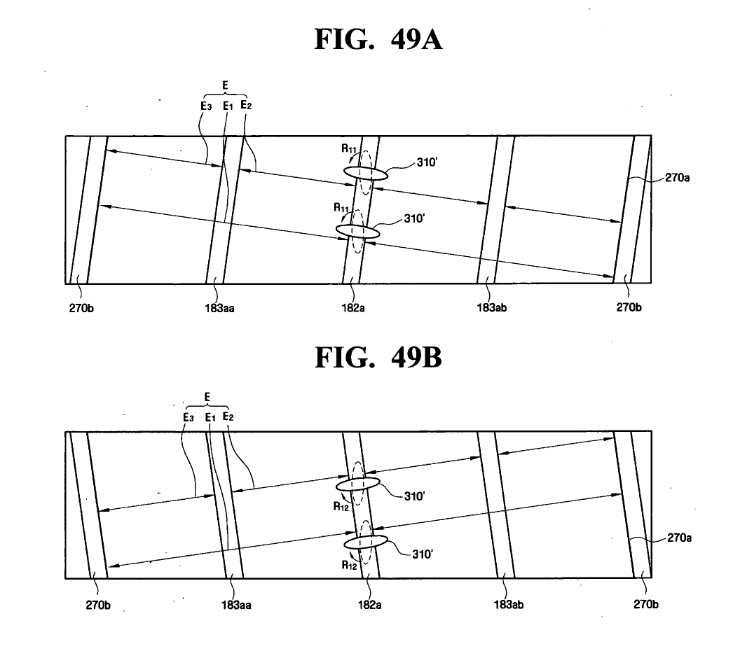

Next, the arrangement of liquid crystal molecules in the ON/OFF state of a thin film transistor of the liquid crystal display according to an embodiment of the present invention will now be described with reference to FIGS. 47 through 49B. FIGS. 48A and 48B are schematic plan views illustrating the arrangement of liquid crystal molecules when the thin film transistor of the liquid crystal display according to an embodiment of the present invention is in an “OFF” state, and FIGS. 49A and 49B are schematic plan views illustrating the arrangement of liquid crystal molecules when the thin film transistor of the liquid crystal display according to an embodiment of the present invention is in an “ON” state.

First, with respect to the arrangement of liquid crystal molecules in an “OFF” state thin film transistor, referring to FIGS. 47 through 48B, the long axes of liquid crystal molecules 310′ are inclined parallel to the rubbing direction of the horizontal alignment films 190 and 280, i.e., to the long side of the pixel area. That is, the liquid crystal molecules 310′ in the upper pixel area positioned above the transverse centerline of the pixel area may have a tilt angle a of about 5 to 30 degrees with respect to the sub-electrodes 182a and 183a, as shown in FIG. 48A. On the other hand, the liquid crystal molecules 310′ in the lower pixel area positioned below the transverse centerline of the pixel area may have a tilt angle a of about −5 to −30 degrees with respect to the sub-electrodes 182a and 183a, as shown in FIG. 48B.

Next, with respect to liquid crystal molecule arrangement in an “ON” state thin film transistor, referring to FIGS. 47 and 49A-49B, when the thin film transistor is turned-on and an image signal is applied to the pixel electrode 182, the electric field E is generated between the first plate 100 and the second plate 200.

The arrangement of the liquid crystal molecules 310′ is determined by the vector summation of the electric field E1 between the sub-electrodes 182a of the pixel electrode 182 and field-generating portions 270b of the common electrode 270, the electric field E2 between the sub-electrodes 182a of the pixel electrode 182 and the sub-branch electrodes 183aa or 183ab of the additional electrode 183, and the electric field E3 between the sub-branch electrodes 183aa or 183ab of the additional electrode 183 and the field-generating portions 270b of the common electrode 270. Thus, the liquid crystal molecules 310′ having positive dielectric anisotropy are rotated in the direction of R₁₁ (FIG. 49A) or R₁₂ (FIG. 49B) such that their long axes are aligned parallel to the field generating direction.

The liquid crystal display according to an embodiment of the present invention has substantially the same characteristics of the liquid crystal display according to an embodiment of the present invention. Further, the liquid crystal display according to an embodiment of the present invention includes sub-electrodes and openings disposed symmetrically with respect to and neither perpendicular nor parallel to the transverse centerline of a pixel area, thereby improving a viewing angle and avoiding the occurrence of a rubbing angle error that may be caused when alignment films are rubbed.

Embodiments of the present invention will now be described with reference to Experimental Examples and Comparative Examples. The following Examples are not to be construed as a limitation of the invention.

First, the characteristics of liquid crystal displays according to embodiments of the present invention and conventional PVA and PLS-mode liquid crystal displays were evaluated through computer simulation using a two-dimensional metal-oxide-semiconductor (2D MOS) device simulator, and the transmittances of the liquid crystal displays obtained through the simulation are presented in Table 1 below. In Table 1, Experimental Examples 1 through 3 are for liquid crystal display samples according to embodiments of the present invention, Comparative Examples 1 and 2 are for PVA and PLS-mode liquid crystal display samples. In Table 1, w is a width of a sub-electrode, a branch electrode, or a field-generating portion between openings of a common electrode (for Experimental Examples 1-3), a width of a pixel electrode or a common electrode (for Comparative Example 1), or a width of a pixel electrode (for Comparative Example 2), 1 is a gap between sub-electrodes or branch electrodes or a width of an opening of a common electrode (for Experimental Examples 1-3), a width of a cutout of a pixel electrode or a common electrode (for Comparative Example 1), or a gap between pixel electrodes (for Comparative Example 2), d is a cell gap, Δn is birefringence, Δε is dielectric anisotropy, and V_{com}, Vₙₚᵢₓ, and V_{add} are voltages applied to a common electrode, a pixel electrode, and an additional electrode, respectively.

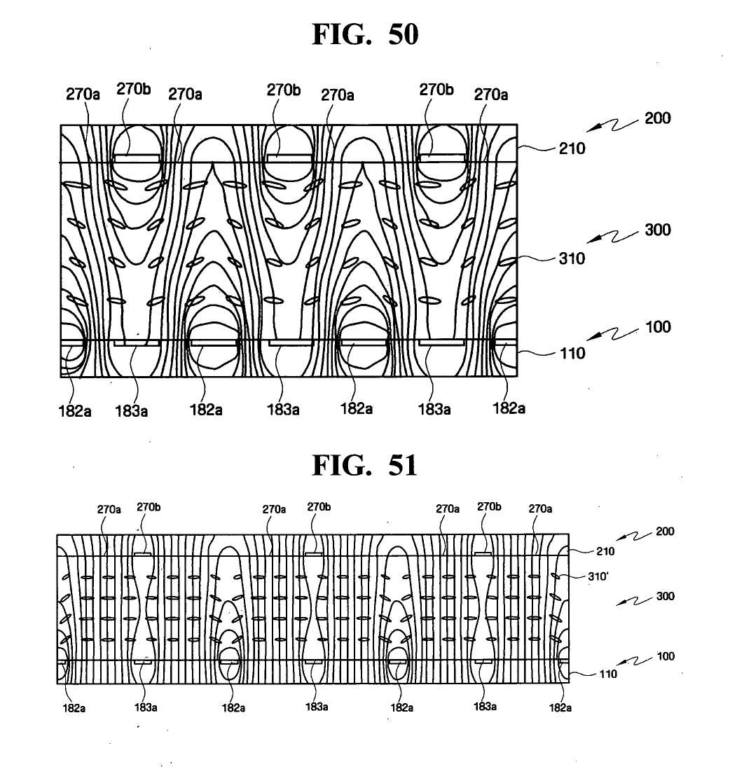

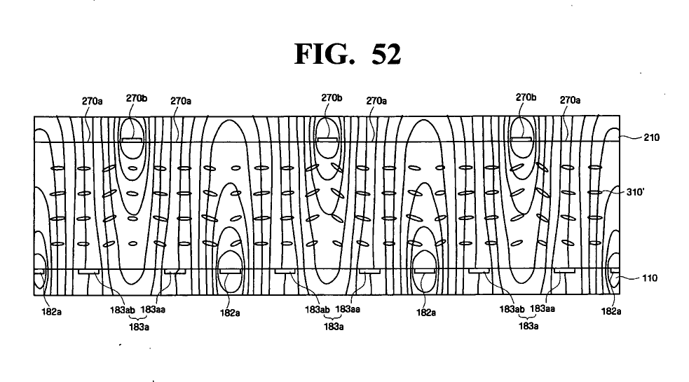

The equipotential lines formed in the “ON” state of thin film transistors of the liquid crystal displays of Experimental Examples 1-3 are diagrammatically illustrated in FIGS. 50 through 52, respectively. FIG. 50 illustrates the equipotential lines formed between sub-electrodes 182a and 183a formed on a first substrate 110 of a first plate 100 and field-generating portions 270b formed on a second substrate 210 of a second plate 200, and the arrangement of liquid crystal molecules 310 having negative dielectric anisotropy, in the liquid crystal display of Experimental Example 1. FIG. 51 illustrates the equipotential lines formed between sub-electrodes 182a and 183a formed on a first substrate 110 of a first plate 100 and field-generating portions 270b formed on a second substrate 210 of a second plate 200, and the arrangement of liquid crystal molecules 310′ having positive dielectric anisotropy, in the liquid crystal display of Experimental Example 2. FIG. 52 illustrates the equipotential lines formed between sub-electrodes 182a and sub-branch electrodes 183aa and 183ab formed on a first substrate 110 of a first plate 100 and field-generating portions 270b formed on a second substrate 210 of a second plate 200, and the arrangement of liquid crystal molecules 310′ having positive dielectric anisotropy, in the liquid crystal display of Experimental Example 3.

TABLE 1
Experimental Results

| | w | l | d | | | V_{com} | Vₚᵢₓ | V_{add} | Transmittance |
|---|---|---|---|---|---|---|---|---|---|
| Samples | (μm) | (μm) | (μm) | Δn | Δε | (V) | (V) | (V) | (%) |
| Experimental | 4 | 9 | 4.6 | 0.080 | −3.8 | 0 | 7.0 | 2.5 | 46.64 |
| Example 1 | | | | | | | | | |
| Experimental | 4 | 36 | 5 | 0.072 | 6.0 | 0 | 7.0 | 0.0 | 45.04 |
| Example 2 | | | | | | | | | |
| Experimental | 4 | 34 | 13 | 0.072 | 6.0 | 0 | 7.0 | 3.5 | 44.28 |
| Example 3 | | | | | | | | | |
| Comparative | 56 | 10 | 4.2 | 0.082 | −3.8 | 0 | 7.0 | — | 43.59 |
| Example 1 | | | | | | | | | |
| Comparative | 4 | 7 | 4.2 | 0.092 | −3.8 | 0 | 7.0 | — | 45.69 |
| Example 2 | | | | | | | | | |

As shown in Table 1 and FIGS. 50 through 52, comparing the simulation results of the liquid crystal displays according to Experimental Examples 1-3 of the present invention and the PVA- and PLS-mode liquid crystal displays according to Comparative Examples 1-2, the transmittances of the liquid crystal displays according to Experimental Examples 1-3 were similar to or greater than those of the liquid crystal displays according to Comparative Examples 1-2.

As described above, liquid crystal displays according to embodiments of the present invention are constructed such that a horizontal electric field can be enhanced, and liquid crystal molecules have various values of positive or negative dielectric anisotropy, thereby realizing improved transmittance and a wider viewing angle.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A liquid crystal display comprising:
a first plate including first and second field-generating electrodes disposed in a pixel area of an insulating substrate and electrically separated from each other in a cross-finger structure, and a first alignment film covering the first and the second field-generating electrodes and rubbed in a first direction;
a second plate formed of an insulating substrate and including a third field-generating electrode having field-generating portions and a plurality of openings and a second alignment film covering the third field-generating electrode and rubbed in a second direction; and
a liquid crystal layer interposed between the first plate and the second plate.

2. The liquid crystal display of claim 1, wherein each of the first and second field-generating electrodes comprises a plurality of sub-electrodes and a connection electrode electrically connecting the sub-electrodes.

3. The liquid crystal display of claim 2, wherein each of the openings is formed at least at each of the sub-electrodes of the first field-generating electrode.

4. The liquid crystal display of claim 1, wherein the second field-generating electrode comprises a plurality of branch electrodes.

5. The liquid crystal display of claim 4, wherein each of the field-generating portions is formed at a region defined between the branch electrodes.

6. The liquid crystal display of claim 1, wherein liquid crystal molecules of the liquid crystal layer have negative dielectric anisotropy.

7. The liquid crystal display of claim 6, wherein each of the sub-electrodes forms an angle of about 60 to 85 degrees with the first direction.

8. The liquid crystal display of claim 1, wherein liquid crystal molecules of the liquid crystal layer have positive dielectric anisotropy.

9. The liquid crystal display of claim 8, wherein each of the sub-electrodes forms an angle of 5 to 30 degrees with the first direction.

10. The liquid crystal display of claim 1, wherein a voltage applied to the second field-generating electrode is smaller than a voltage applied to the first field-generating electrode and equal to or greater than a voltage applied to the third field-generating electrode.

11. A liquid crystal display comprising:
a first plate including a pixel electrode and an additional electrode in a cross-finger structure disposed in a pixel area of an insulating substrate, each of the pixel electrode and the additional electrode including a plurality of sub-electrodes and a connection electrode which connects the sub electrodes with one another, and a first horizontal alignment film covering the pixel electrode and the additional electrode and rubbed in a first direction;
a second plate formed on an insulating substrate and including a common electrode having a field-generating portion and a plurality of openings, and a second horizontal alignment film covering the common electrode and rubbed in a second direction; and
a liquid crystal layer interposed between the first plate and the second plate.

12. The liquid crystal display of claim 11, wherein the sub-electrodes have a width of about 7 μm or less.

13. The liquid crystal display of claim 11, wherein the openings are formed to correspond to the sub-electrodes of the pixel electrode.

14. The liquid crystal display of claim 11, wherein the sub-electrodes are arranged symmetrically with respect to a transverse centerline of the pixel area, the sub-electrodes being neither perpendicular nor parallel with respect to the transverse centerline of the pixel area.

15. The liquid crystal display of claim 11, wherein the openings are arranged symmetrically with respect to the transverse centerline of the pixel area, the openings being neither perpendicular nor parallel with respect to the transverse centerline of the pixel area.

16. The liquid crystal display of claim 11, wherein liquid crystal molecules of the liquid crystal layer have negative dielectric anisotropy.

17. The liquid crystal display of claim 16, wherein the openings have a width in a range of about 8 to 20 μm.

18. The liquid crystal display of claim 16, wherein each of the sub-electrodes positioned in an upper pixel area with respect to the transverse centerline of the pixel area forms an angle of 60 to 85 degrees with the first direction.

19. The liquid crystal display of claim 11, wherein liquid crystal molecules of the liquid crystal layer have positive dielectric anisotropy.

20. The liquid crystal display of claim 19, wherein the openings have a width in a range of about 20 to 40 μm.

21. The liquid crystal display of claim 19, wherein each of the sub-electrodes positioned in an upper pixel area with respect to the transverse centerline of the pixel area forms an angle of 5 to 30 degrees with the first direction.

22. The liquid crystal display of claim 11, wherein a voltage applied to the additional electrode is smaller than a voltage applied to the pixel electrode and equal to or greater than a voltage applied to the common electrode.

23. A liquid crystal display comprising:
a first plate including a pixel electrode, an additional electrode disposed in a pixel area of an insulating substrate and a first horizontal alignment film covering the pixel electrode, the pixel electrode and the additional electrode configured in a cross-finger structure and including a plurality of sub-electrodes and a connection electrode connecting the sub-electrodes with one another, each of the plurality of sub-electrodes including a plurality of sub-branch electrodes;
a second plate formed on an insulating substrate and including a common electrode having a field-generating portion and a plurality of openings, and a second horizontal alignment film covering the common electrode and rubbed in a second direction; and
a liquid crystal layer interposed between the first plate and the second plate.

24. The liquid crystal display of claim 23, wherein the plurality of sub-branch electrodes have a width of about 7 μm or less.

25. The liquid crystal display of claim 23, wherein the field-generating portion between the openings are formed between the sub-branch electrodes of the additional electrodes.

26. The liquid crystal display of claim 23, wherein the plurality of sub-branch electrodes is arranged symmetrically with respect to the transverse centerline of the pixel area, the plurality of sub-branch electrodes being neither perpendicular nor parallel with respect to the transverse centerline of the pixel area.

27. The liquid crystal display of claim 23, wherein the openings are arranged symmetrically with respect to the transverse centerline of the pixel area, the openings being neither perpendicular nor parallel with respect to the transverse centerline of the pixel area.

28. The liquid crystal display of claim 23, wherein liquid crystal molecules of the liquid crystal layer have negative dielectric anisotropy.

29. The liquid crystal display of claim 28, wherein the openings have a width in a range of about 8 to 20 μm.

30. The liquid crystal display of claim 27, wherein each of the sub-electrodes positioned in an upper pixel area or in a lower pixel area with respect to the transverse centerline of the pixel forms an angle of 60 to 85 degrees with the first direction.

31. The liquid crystal display of claim 23, wherein liquid crystal molecules of the liquid crystal layer have positive dielectric anisotropy.

32. The liquid crystal display of claim 31, wherein the openings have a width in a range of about 20 to 40 μm.

33. The liquid crystal display of claim 31, wherein each of the sub-electrodes positioned in an upper pixel area or in a lower pixel area with respect to the transverse centerline of the pixel area forms an angle of 5 to 30 degrees with the first direction.

34. The liquid crystal display of claim 23, wherein a voltage applied to the additional electrode is smaller than a voltage applied to the pixel electrode and equal to or greater than a voltage applied to the common electrode.
